(19) United States
(12) Patent Application Publication
(10) Pub. No.: US 2003/0149653 A1
(43) Pub. Date: Aug. 7, 2003

(54) Method and apparatus for conducting financial transactions

(76) Inventors: Neill Penney, Surrey (GB); David Wright, New Rochelle, NY (US)

Correspondence Address: COVINGTON & BURLING, ATTN: PATENT DOCKETING, 1201 PENNSYLVANIA AVENUE, N.W., WASHINGTON, DC, 20004-2401, US

(21) Appl. No.: 10/237,972

(22) Filed: Sep. 10, 2002

Related U.S. Application Data
(60) Provisional application No. 60/318,577, filed on Sep. 11, 2001.
(60) Provisional application No. 60/330,798, filed on Oct. 31, 2001.
(60) Provisional application No. 60/352,512, filed on Jan. 31, 2002.

(51) Int. Cl. G06F 17/60

(52) U.S. Cl. 705/37

(57) ABSTRACT

Method and apparatus for conducting financial transactions that allows traders, market makers, dealers, and liquidity providers to negotiate with multiple customers simultaneously, and receive and respond to transaction solicitations and amendment requests in real time. The invention, which may be accessed over an interconnected data communications network, such as the Internet, using a standard Web browser, automatically provides traders with up-to-date market rates as solicitations are received, and provides a graphical user interface with sorting and filtering capabilities to organize displays to show pending and completed transactions according to user preferences. Counterparty customers engaged in transactions with the traders and dealers using the system benefit by being able to negotiate with multiple providers simultaneously, and by receiving real-time, context-sensitive transaction status messages and notifications as the negotiations take place. An optional transaction status database records transaction events in real-time and provides transaction archiving and auditing capabilities superior to conventional manual transaction systems.

### RELATED APPLICATIONS

This application is related to and claims priority under 35 U.S.C. §119 to provisional application No. 60/318,577, filed on Sep. 11, 2001, provisional application No. 60/330,798, filed on Oct. 31, 2001, and provisional application No. 60/352,512, filed on Jan. 31, 2002, all of which are incorporated into this application in their entirety by this reference. This application is also related to a co-pending application entitled, METHOD AND APPARATUS FOR AMENDING FINANCIAL TRANSACTIONS, application Ser. No. ______, filed on even date herewith and assigned to the assignee of the present application, and the entirety of that application is also incorporated herein by this reference.

### BACKGROUND OF THE INVENTION

1. Field of Art

The present invention relates generally to financial transaction systems and, more specifically, to financial transaction systems where at least a portion of the transaction is conducted over an interconnected data communications network, such as the Internet.

2. Related Art

In today's global market, money flows freely between investors and borrowers, and buyers and sellers, across international borders. Money markets, for example, allow market participants to borrow and lend money. In a money market transaction, one counterparty—the borrower—borrows money from the other counterparty—the lender—at a specified rate for a specified period of time. Money market instruments include coupon bearing instruments, such as certificates of deposit (CDs) and repurchase agreements, discount instruments, such as treasury bills, (T-bills) and commercial paper, and derivatives, such as forward rate agreements, interest rate futures and interest rate options.

In another example, foreign exchange (“FX”) markets allow market participants to exchange one currency for another. In an FX transaction, one counterparty buys a specified currency from the other counterparty in exchange for another currency. FX market instruments include spot, forward and swap agreements (defined below).

As investments, most money market and FX instruments are “liquid,” meaning that they can be bought and sold rapidly. This liquidity is the reason many corporate treasurers use these markets to lend or sell spare cash to banks as a way of temporarily “parking” the spare cash in a short-term low-risk investment vehicle before making a financial decision. The banks use the spare cash to make loans to borrowers who need short-term financing. These borrowers may include, for example, other banks, corporations, governments and supranational organizations, such as the World Bank.

Borrowers, lenders, sellers and buyers in these markets conduct their transactions through dealers, also called “traders,” who borrow and lend money market instruments or buy and sell FX instruments. The dealers and traders, who are referred to as “market-makers” or “liquidity providers,” quote prices that they are willing to buy (or borrow) the instruments they deal in, as well as prices they are willing to sell (or lend) the instrument. The borrowing or buying price is known as the “bid,” and the lending or selling price is known as the “offer.” The difference between these two prices is known as the “bid-offer spread,” and it is this spread which generates profits for market-makers, as they are always buying and borrowing slightly more cheaply than they are selling and lending.

For many years, liquidity providers and their customers (the buyers, sellers, lenders and borrowers who do business with liquidity providers) would negotiate, execute and confirm transactions, which are often called “deals,” from start to finish using only manual systems, either by meeting in person (such as at a stock or commodity exchange) or by using telephones and fax machines. But as the markets have grown, and as trading and dealing activities have expanded to cover 24 hours per day, the manual systems have been found to be too slow and inefficient to keep up with market requirements. Manual systems, for example, do not always provide adequate access to the people, prices and transaction records required to accommodate the fast pace and higher volumes of today's markets, or to deal with the financial risks associated with engaging in these transactions. Manual systems also typically do not provide adequate or timely access to current market news, market rates, market research and other information market participants need to have available and at their fingertips while they are making deals.

Another problem with manual systems is that they typically allow customers, dealers and providers to communicate with only one counterparty at a time, which can be a very time-consuming and unreliable way to obtain the best prices. Yet another problem with manual systems is that the records for these transactions, which often total very large transfers of money (and therefore create large financial exposures), frequently consisted of hastily-created, handwritten notes and faxes, which are sometimes lost, smudged, illegible, or otherwise unavailable when they are needed the most, such as during a financial audit. These and other problems made it extremely difficult to review, understand, and/or reconstruct exactly what happened during the course of a very large or very complex transaction negotiated and completed using manual systems.

Automated online transaction systems for customers and liquidity providers have been introduced in an attempt to address some of these problems. But such systems have so far failed to solve many of the most troubling aspects of the older manual systems. For example, like the manual systems, conventional online transaction systems typically do not connect customers to multiple banks and providers simultaneously, which means customers must still spend an unacceptable amount of time shopping proposed transactions around for the best prices, when they would much rather have a number of banks and providers competing for their business. Moreover, the conventional online trading systems do not provide customers with real-time, context-sensitive feedback on the status of proposed transactions.

Many conventional systems also do not allow dealers to communicate with multiple customers simultaneously, which prevents them from negotiating multiple deals simultaneously and thereby achieving the larger business volumes they constantly seek. Even in cases where simultaneous access to multiple customers is provided, conventional online transaction systems do not provide users with alerts and status updates that conform, in terms of their content and timing, with the conventions, standards and accepted business practices normally associated with these transactions.

Another problem with conventional online transaction systems is that they do not provide a way for customers to submit or providers to respond to requests to change or amend previously submitted deals, except by resorting to the older manual systems, e.g., telephones and fax machines. Nor do these systems provide users with the tools they need, such as transaction sorters and display filters, to streamline their workflows and organize their displays according to preference.

Accordingly, there is need for an automated online transaction system that allows customers: (1) to negotiate with multiple providers simultaneously; (2) to receive real-time, context-sensitive status messages and notifications from providers; and (3) to submit changes and amendments to previously submitted transactions without having to resort to using manual systems. There is a further need for automated online transaction systems that provide market makers, dealers, and liquidity providers with the ability: (1) to negotiate with multiple customers simultaneously; (2) to receive solicitations in an inbox shared by multiple users; (3) to respond to requests to change or amend previously submitted deals; (4) to receive up-to-date market rates as proposed transactions are received; and (5) to sort and filter their displays to show pending and completed transactions according to preference.

The present invention addresses all of these problems with conventional online transaction systems, as well as numerous other long-felt but so far unfulfilled needs.

### SUMMARY OF THE INVENTION

In general, the present invention comprises a computer-implemented method for conducting a financial transaction, comprising the steps of: (1) receiving, via a data communications channel, a solicitation for the financial transaction; (2) presenting, on a user workstation, an alert indicating that the solicitation has arrived; (3) receiving from the user workstation an activation signal, generated in response to an input of a user, indicating that the user has selected the solicitation for dealing; and (4) responsive to the generation of the activation signal, displaying the proposed financial transaction to the user, receiving a transaction term from the user for the financial transaction, and sending the transaction term over the data communications channel. The “user” may be, for example, a trader, a market maker, a liquidity-provider, or a dealer.

The financial transaction may comprise a currency exchange transaction, a money market transaction, or any other type of financial transaction. The solicitation could be a request for quotes (RFQ) for the financial transaction, in which case the transaction term supplied by the user is a price quote.

In a preferred embodiment, the alert may comprise a visual signal, such as a summary of the solicitation, a flashing icon, or both. Moreover, the alert may be presented on a multiplicity of user workstations and another user may be prevented from selecting the solicitation for dealing after a first user already selects it. The activation signal may be generated by “selecting” the summary of the financial transaction, the solicitation or both, with a pointing device, such as a mouse, attached to the user's workstation. Typing a designated set of characters on the user's workstation may also generate the activation signal.

Customers often want or need to make changes to previously submitted or previously confirmed transactions. Accordingly, the solicitation may also comprise a request to amend, cancel or rebook a financial transaction, or a request to change a value date or execution rate for a previously submitted financial transaction. The solicitation may also compromise a request to use a specified account to execute a previously submitted financial transaction, a request to rebook the financial transaction at an average rate, or a request to apply the rate of a previous financial transaction to the current financial transaction. The solicitation may also comprise a combination of two or more of such requests. Notably, the previously submitted transaction may or may not have been submitted using one or more of the manual methods for conducting financial transactions, such as by fax or telephone for example.

In an aspect of the invention, the method may further include the step of sending, responsive to the generation of the activation signal, a notification to the customer (or to another computer) that the solicitation has been selected for dealing. The method may also include the step of receiving from a customer (or another computer system) an offer to deal responsive to the transaction term supplied by a provider.

In a preferred embodiment, the method further includes the steps of: (5) determining whether the dealer for the transaction has sent a command to withdraw the transaction term; (6) determining whether the user has sent a command to stop dealing on the financial transaction; (7) determining whether the user has sent a command to deny the financial transaction; and (8) withdrawing the transaction term if the offer to deal is not received during a specified period of time. The method of the present invention may further include the steps of: (9) receiving from the user a deal completion signal, such as an acceptance or a rejection, responsive to an offer to deal signal received from a customer; and (10) passing the deal completion signal back to the customer.

Further still, the method may include receiving, via a second data communications channel, an indicative price for the financial transaction, which is based at least in part on a detail of the financial transaction, such as a foreign exchange currency pair. The data communications channel and the second data communications channel may be the same communication channel or they may be different channels. The method may ultimately include the steps of executing the financial transaction, and sending, via the second data communications channel, a confirmation that the transaction was executed.

In yet another aspect of the invention, the method for conducting a financial transaction comprises: (1) receiving a solicitation for the financial transaction from a first user; (2) presenting the solicitation to a second user; (3) receiving from the second user a transaction term responsive to the solicitation; (4) transmitting the transaction term to the first user; (5) receiving from the first user an offer to deal responsive to the transaction term; (6) transmitting the offer to deal to the second user; (7) receiving from the second user a deal completion signal responsive to the offer to deal; (8) sending the deal completion signal to the first user; (9) executing the financial transaction; and (10) sending a confirmation. This method may further include creating or modifying a transaction status database as one or more of these steps are performed.

In another aspect, the invention provides a graphical user interface for conducting a proposed financial transaction, comprising: (1) a first display region configured to display an alert in response to a receipt of a solicitation to execute the proposed financial transaction, and a user-activatible control configured to generate a signal that a user has selected the solicitation for dealing. The user interface also has a second display region configured to show, in response to the generation of the signal, a deal ticket summarizing the proposed financial transaction. The deal ticket is configured to receive input from the user comprising a transaction term for the proposed financial transaction. In addition to containing a summary of the proposed transaction, the deal ticket comprises, in a preferred embodiment, at least one of the following details for the proposed financial transaction: the customers name; a currency pair; and an elapsed time since the solicitation was received. In embodiments, the first display region may be further configured to display a list of solicitations received by a multiplicity of users, along with a current status for each solicitation in the list. Moreover, the list of solicitations may be sorted, and displayed according to a set of user preferences.

In another aspect, the invention comprises a computer-readable storage medium, or computer-executable software code stored on a computer-readable storage medium, for conducting a financial transaction. This aspect comprises: (1) code configured to receive, via a data communications channel, a solicitation for the financial transaction; (2) code responsive to the receipt of the solicitation, configured to present, on a user workstation, an alert indicating that the solicitation has arrived, and a user-activatible control configured to generate an activation signal, responsive to the input of a user; and (3) code responsive to the generation of the activation signal, to display the financial transaction to the user, to receive a transaction term from the user for the financial transaction, and to send the transaction term over the data communications channel. The computer-readable storage medium may further include code responsive to the receipt of the solicitation, for presenting the alert on a multiplicity of user workstations and code responsive to the generation of the activation signal, to prevent another user from selecting the solicitation for dealing after a first user already selects it.

### Features and Advantages

The present invention allows market makers to receive and respond to solicitations to conduct or amend financial transactions, and provide immediate feedback and confirmations to customers, all automatically, and all according to the conventions and practices typically followed in conducting with such transactions. In the foreign exchange market context, for example, market-makers are be able to quote, re-quote and withdraw prices on spots, forwards, swaps, and single spot portfolios (SSPs) and multi-spot portfolios (MSPs) on multiple deals simultaneously, and customers can submit requests for such quotes to multiple market makers simultaneously.

Accordingly, one feature of the present invention is that multiple users of a large market maker organization, such as a bank, can monitor and receive solicitations (e.g., RFQs) through a shared, real-time blotter or inbox, and solicitations “picked up” for dealing by one of those multiple users are “locked” so that a second user cannot also provide quotes for the “picked up” solicitation.

Another feature of the invention is that it presents a “picked up” solicitation to a dealer in a “deal ticket” which, in a preferred embodiment, is seeded with one or more current market rates, referred to as “indicative rates,” for the proposed transaction, thereby letting the dealer know immediately what would be a “fair” and/or authorized response to the solicitation, and allowing the dealer to select and/or change the rate before sending it to the customer. Still another feature of the invention is that it can be configured to inform the customer when a deal has been picked up by a dealer.

Yet another feature of the invention is that, when a customer responds to a price quote provided by a dealer, the system can be configured to automatically accept and book the deal, or reject it, depending on whether the quoted price is still available to the customer. In addition, each dealer may negotiate multiple solicitations simultaneously, sort and filter their views of completed and pending solicitations and transactions, view the details of all completed solicitations, and download details of completed and pending transactions in various standard formats, such as comma-separated values (CSV) format. Dealers may also communicate with customers using an in-deal chat feature.

An advantage of the invention is that it automatically provides an audit trail for all transactions because each event in the negotiation and completion of the transaction is logged in a transaction status database as it occurs. This typically does not happen when transactions are negotiated, amended and/or executed using conventional tools, such as by telephone or facsimile.

Another advantage of the invention is that it can be configured to work over the Internet, or any other data communications network, using standard Hypertext Transfer Protocol (“HTTP”) and HTTP over Secured Socket Layer (“HTTPS”) ports and “streaming” technology. Thus, customers and dealers may use a standard web browser, such as Internet Explorer Version 5.0 or later, to gain secured access to some or all of the above-described features. Moreover, communication between a server component and a client component of the invention may be encrypted to insure the integrity and confidentiality of the transaction data.

Another advantage is that a single instance of the server component of the invention will support multiple users at multiple banks simultaneously. The invention may be configured to use a single database or multiple databases, with no requirement to create new database tables when a new bank or liquidity provider is added to the system. Other servers, such as a Web Server, may also be shared across multiple banks.

Still another advantage of the invention is that it may be configured to interface with a multiple-bank trading platform, such as the one provided by FXall, Inc., of New York, N.Y., through a set of library routines making up an transaction application programming interface (API). The FXall trading platform, however, is only one example of a trading platform with which the invention described herein will work. The invention is designed to be equally applicable to other trading platforms. Thus, the references to FXall's trading platform below are for exemplary purposes, and should not be construed to limit the scope and applicability of this invention.

### BRIEF DESCRIPTION OF THE DRAWINGS

The invention will be better understood with respect to the accompanying drawings, which constitute a part of this specification and include exemplary embodiments of some of the various forms of the invention. In these drawings:

FIG. 1 is a high-level block diagram of a provider pricing tool configured according to one embodiment of the present invention.

FIG. 2 is a high-level flow diagram illustrating the steps performed by a system configured to conduct financial transactions in accordance with an embodiment of the present invention.

FIG. 3 depicts a logical diagram of a database schema for a transaction status database that may be used in an embodiment of the present invention.

FIGS. 4 through 10, 11A, 11B and 12 contain data flow diagrams that illustrate the message flows triggered by the use of certain major entry points in a transaction server configured to operate in accordance with the invention.

FIGS. 13 through 21 depict exemplary graphical user interface screens that can be used in embodiments of the present invention.

FIG. 22 contains a flow diagram illustrating the steps performed in one embodiment of the invention to determine and display the relationship between the bid and ask sides of a deal.

FIG. 23 contains a flow diagram illustrating the typical sequence of messages exchanged by certain components of the invention for a typical FX transaction.

FIGS. 24-27 contain flow diagrams illustrating the steps performed by embodiments of the present invention for certain types of foreign exchange transactions.

### DETAILED DESCRIPTION OF PREFERRED EMBODIMENTS

Although the detailed description of preferred embodiments provided herein refers primarily to foreign exchange (FX) deals, these references are only meant to illustrate in clearer detail how the invention may be applied in that particular context, not to serve as a limitation on the applicability of the invention in other contexts. Therefore, such references should not be construed to remove from the scope of the present invention other kinds of financial transactions that could benefit from its application, such as fixed income, equities and money market transactions.

I. Definition of Terms

As used in this description, except to the extent that the context indicates otherwise, the following terms may be understood with reference to the definitions provided below.

1. FX Terms

A “foreign exchange” or “FX” transaction (or “deal”) is a contract to exchange one currency for another at an agreed rate on a specified delivery date, also called a “value date.”

A “value date” or “settlement date” is the date on which the exchange of currencies will take place.

The terms “forward deal,” “forward agreement,” forward outright deal” or “FX outright transaction” refers to an agreement to buy one currency on a specified future value date at a rate that is agreed upon today (i.e. buy X units of one currency, or sell Y units of another currency) on any date other than the FX spot date. There is no exchange of funds until the future value date arrives. As a matter of convenience, it is customary in some markets for participants engaged in negotiating and executing these transactions to rely on a set of standard settlement dates. In the foreign exchange market, for example, dealers, traders, buyers and sellers rely on a set of standard “forward settlement dates,” sometimes called “forward tenors,” which occur one week, one month, two months, three months, six months or twelve months after the spot settlement date (which is defined below). These standard forward settlement dates are usually written as: “1M” for one month, “2M” for two months, “3M” for three month, and so on. In practice, market participants will either agree on a “standard” forward settlement date, or agree on a different day.

The terms “FX spot deal,” “spot trade” and “spot agreement” refer to a transaction or agreement to exchange a single foreign currency for another (i.e., to buy X units of one currency, sell Y units of another currency) on the FX spot date.

The “FX spot date” is usually two working days from the date the agreement is made and is the most liquid (i.e. cheapest) date to buy or sell currency on a given trading date.

The term “FX points” refers to the difference at any time between the price for an FX outright and an FX spot.

The term “swap” or “swap agreement” refers to a deal involving the simultaneous purchase and sale, or sale and purchase, of a specified amount of one currency against another for two different value dates. Although a swap is a single transaction with a single counterparty, the transaction has two value dates (or “legs”) when the exchanges of funds occur.

A “spot rate” is a rate (expressed as combination of a bid (buy) price and an offer (sell) price) at which a market maker will buy and sell the base currency against another currency.

The term “All-in rate” typically refers, in the context of outrights, to the overall rate at which the exchange will occur. The all-in rate is calculated by adding the spot rate and the FX points (the price adjustment).

A “single spot portfolio” (SSP) is an FX deal involving one or more legs in a single currency pair on any combination of value dates. The dealt currency should be the same for all legs. SSP price quotes typically have four components: a spot rate, the FX points for each of the non-spot value dates, and the all-in rates for each of the non-spot value dates.

A “multiple spot portfolio” or “multi-spot portfolio” (MSP) is an FX deal involving one or more legs in multiple currency pairs on any combination of value dates. The dealt currency is not the same for all legs.

2. Parties

The term “Provider” is typically a shorthand reference to a “Liquidity Provider.” A “Liquidity Provider” is typically a financial institution, such as a bank, that serves as a market maker in a trading system. Liquidity Providers quote prices in response to requests from “customers.”

The term “bank,” as used herein, is typically used interchangeably with “Provider.”

The term “dealer” or “trader” typically refers to an employee of the bank or Liquidity Provider who monitors the system from the Provider side and responds to Customers' requests for price quotes.

The term “Customer” typically refers to a user of the system who is not a Bank, Provider, dealer or trader. Customers initiate the dealing process by asking one or more Providers for a price on a particular FX instrument, such as a swap, forward or spot transaction. While “customer” is typically essentially interchangeable with “user,” in some cases, depending on the context, a “customer” may also refer to an aggregation of users, as, for example, in a company.

3. Features

The term “Provider Pricing Tool,” or PPT, refers to a system configured in accordance with the present invention, which enables Providers to receive and respond to price and amendment requests submitted by Customers. The PPT may also be referred to, in some embodiments of the present invention, as a “Treasury Center” or “Treasury Desk” program, or a “treasury desk application.”

The term “Transaction Status Database” refers to one of the database components for a Provider Pricing Tool of the present invention or a Transaction Amendment Tool of the invention disclosed in co-pending application Ser. No. ______, entitled “METHOD AND APPARATUS FOR AMENDING FINANCIAL TRANSACTIONS.” In embodiments of the invention, the Transaction Status Database holds records of pending and completed deals, a history of transactions and amendments made to them.

4. Amendment Types

The term “Post trade allocation(s)” (“PTA”) refers to functionality, typically used by a Customer fund manager that enables a user to allocate the value units of a trade to a plurality of different accounts. Each value date in the trade (e.g. buy $100m against EUR at 0.8700 $ per EUR on Feb. 10, 2002) is split into multiple exchanges on the same value date and at the same exchange rate. Each exchange is typically for a different fund managed by a different fund manager. For example, the deal above might be split into two transactions: buy $120m against EUR at 0.8700 $ per EUR on Feb. 10, 2002 for FUND1 and sell $20m at 0.8700 $ per EUR on Feb. 10, 2002 for FUND2). In an embodiment of the invention, the total value of all the FX transactions allocated across all the funds is usually very close to the original amount traded. However, in an embodiment, the Provider will allow small differences at its discretion.

The term “value date to follow” (“VDTF”) means the value date of a proposed transaction will be provided at a later time. Because of the way the dealing process works, it may be more convenient for the Customer to hold off on identifying the value date for a proposed transaction at execution time. For instance, a customer who proposes to buy an FX outright may inform the Provider at execution time that the value date is to be provided at a later time. Later, the Customer informs the Provider of the desired value date, and the Provider informs the Customer of the change in price arising from changing the value date. Once the Customer agrees to the price change, the amendment is complete.

The term “Rebook at Average Rate” (“RAR”) is used to describe a transaction in which a Customer requests combining into a single large deal, several smaller deals. Before proceeding with the confirmation process, the Customer asks the Provider to rebook the multiple small deals as a single large deal with a new exchange rate. The parties calculate the effective exchange rate the Customer has achieved over all the small deals (i.e., the “average rate”) in order to book the single large deal.

The term “Cancel and Rebook” is used in situations where the Customer submits an arbitrary request to change or correct a detail on a trade (e.g. because the amount is wrong, the value date is wrong, or the Customer accidentally selected “Buy” instead of “Sell”). If the bank agrees to the change and the Customer has agreed to any price changes arising from the modification in trade details, the parties then adjust their deal records in their trade systems. In an embodiment of the invention, for Cancel and Rebook, the approach is to cancel out the original deal, add a new deal with the modified details into the trade system, and create a “Rebooking Link” that connects the two deals. This helps preserves an audit trail in the trading systems.

5. Miscellaneous Concepts

The term “Straight-through-Processing” refers to the end-to-end automation of the trading process from order to settlement. It involves the seamless, automated, electronic transfer of trade information to all parties involved in the trading cycle as early as possible.

The terms “Authentication” and “Entitlements Management” refers to the ability to control which users can carry out which activities in a given computer system.

The term “Quick Trade” refers to a straightforward way to execute a trade on the trading platform offered by FXall, Inc. In a Quick Trade, the Customer opens a deal ticket and enters the currency pair, amount, value date and choice of banks. The Customer then submits the details to a transaction server and prices from the selected Providers appear in the Quick Trade Ticket. To deal, the Customer clicks on the price from one of the Providers.

The term “Direction” of the block (as in “allocations can be in same or opposite direction as block, to support netting”) can be understood with reference to the following example: If the block was a “buy” of EUR and “sell” of USD, an allocation is in the same direction if it is also a buy of EUR and sell of USD and in the reverse direction if it is a sell of EUR and a buy of USD.

The term “uneven swap” refers to a situation where the legs of an FX swap involve different amounts of the dealt currency. By contrast, if both legs of an FX swap involve the same amount of the dealt currency, the swap is said to be even. For example, if a Customer wishes to buy $10m against GBP (“GBP” being the code conventionally used for British sterling currency) at the near date and sell $10m against GBP at the far date the swap is even. However, if the Customer wants to buy $10m against GBP at the near date and sell $11m against GBP at the far date, the swap is uneven.

The term “Mismatch” is used to describe situations where the sum of transaction allocations do not match total amount of FX as the original deal. In such cases, there is said to be a mismatch in the amounts between the allocations and the original deal.

6. Acronyms

API—Application Programmer Interface. Used colloquially without expansion to denote a computer-to-computer interface.

OMS—Order Management System. An Order Management System is used by a Customer to maintain a record of which FX deals need to be executed in the market, who should execute them, etc. Once a deal is executed, the OMS is updated with the execution rate for each deal.

SSP—Single Spot Portfolio. A foreign exchange transaction or “deal” involving multiple value dates for a single currency pair. The Provider quotes a single spot rate (hence the name) together with FX points for each value date.

MSP—Multiple Spot Portfolio. A foreign exchange transaction or “deal” involving multiple value dates for multiple currency pairs.

Provider Transaction API—Application programming interface used by Provider banks to interact with the PPT Server and, optionally, with each bank's rate engine and pricing software. Through this interface, which resides and executes on the Providers' computers, the PPT Server sends RFQs received from Customers, Providers send back quotes, and Customers accept/reject the Provider's quotes.

RFQ—Request For Quote. A trading protocol whereby the customer initiates the trade by asking for a price on a particular currency pair, value date, and amount. The bank responds by sending a price. In order to accept the price, the Customer sends the Provider an “Offer to Deal.”

PTA—Post Trade Allocation

VDTF—Value Date to Follow

RAR—Rebook at Average Rate

C&R—Cancel and Rebook

JVM—Java Virtual Machine. A software component used to run Java programs.

SSO—Single Sign-On

USD—United States Dollars.

GBP—United Kingdom Sterling

JPY—Japanese Yen

CHF—Swiss Franc

EUR—European Euro

CAD—Canadian Dollars

II. Overview of the Invention

The present invention, which is sometimes referred to as a “Provider Pricing Tool,” allows a Provider to use a data communications network, such as the Internet, to receive and respond to a solicitation to conduct a transaction. A Customer connected to the same data communications network sends the solicitation, which may comprise an RFQ or a request to amend a previously submitted transaction, to the Provider. In one embodiment, the Provider logs onto a Web server over the Internet, downloads a relatively generic pricing tool applet to a local workstation, and uses the applet to connect directly to a provider pricing tool server. The applet monitors solicitations (along with current market rates) and sends an alert to the Provider when a solicitation arrives. The Provider may type or select a response (e.g., price quote) to the solicitation into the applet, which passes the response back to the provider pricing tool server, which in turn passes the response to the Customer.

In another embodiment, the Provider uses a custom application program incorporating calls to a set of library routines (collectively referred to as a “provider transaction API”), instead of the applet, to communicate with the provider pricing tool server indirectly through a transaction server. In other words, the program running on the Provider workstation, and being used by the Provider to receive solicitations and provide responses, is an API, preferably written especially for the Provider's system, and not a provider pricing tool applet downloaded from the provider pricing tool server. In this case, the API may also be coupled to a separate rate engine (or rate “feed”), a separate pricing tool, or both.

The Customer may submit the solicitations by logging into and using a transaction tool applet, an amendment tool interface, or both, which may or may not be downloaded from a transaction server or an amendment tool server. These applets are configured to accept input from the Customer comprising solicitations or offers to deal responsive to the Provider's quotes and to send the solicitations or offers to deal to the transaction server or amendment tool server, which passes them directly to an API, or to the provider pricing tool server, which passes them to the provider pricing tool applet, depending on which program the Provider is using. Notably, the Customer is not required to use the transaction tool applet or the amendment tool interface to submit solicitations. Instead, the Customer may elect to submit solicitations by logging directly into the transaction server and typing in proposed transaction details, or else by cutting, pasting or importing proposed transaction details from other trading applications and platforms. Either way, the proposed transaction details are accepted by the transaction server or the amendment tool server, and handled appropriately.

The solicitation may be a request for an amendment of a previously submitted transaction. An amendment request may involve, for example, a request to change a value date, a net amount or an account allocation for a previously executed trade. If the solicitation comprises an amendment request, it is passed to the amendment tool server (it may or may not pass through the transaction server first). The amendment tool server passes the solicitation to the provider pricing tool applet (via the PPT Server) or to the provider amendment API, as the case may be, running on the Provider's workstation. The amendment tool server, the provider amendment API and amendment tool interface are also components of an invention claimed in co-pending application Ser. No. ______, entitled “METHOD AND APPARATUS FOR AMENDING FINANCIAL TRANSACTIONS,” which was filed on even date herewith, is assigned to the assignee of the present application, and which is incorporated in its entirety into this application by reference. Nevertheless, the provider pricing tool applet of the present invention may be configured, as described below, to handle amendments for Providers who do not wish to install their own provider amendment API to handle them.

In addition to the provider pricing tool server, the provider pricing tool applet, the provider transaction API, the transaction server, the transaction tool applet, the amendment tool server and the amendment tool interface briefly described above, the present invention may also include other components, such as one or more transaction status databases, authentication and entitlement systems, indicative rate engines, web page servers, and the like, to provide additional functionality, as described in more detail below.

III. High-Level Architecture Description

A high-level description of the overall architecture for the present invention, followed by a more detailed description of some of its components (e.g., the provider pricing tool server, the provider pricing tool applet, database schema, etc.), is now provided.

As stated above, Customers typically, although not necessarily, download and launch a small transaction or amendment application program, referred to as an “applet”, which allows them to initiate or amend transactions with multiple Providers, and to receive responses from multiple Providers via a PPT Server. For foreign exchange transactions, for example, Customers request price quotes for spot, forward, swap, single-spot portfolio and multi-spot portfolio transactions.

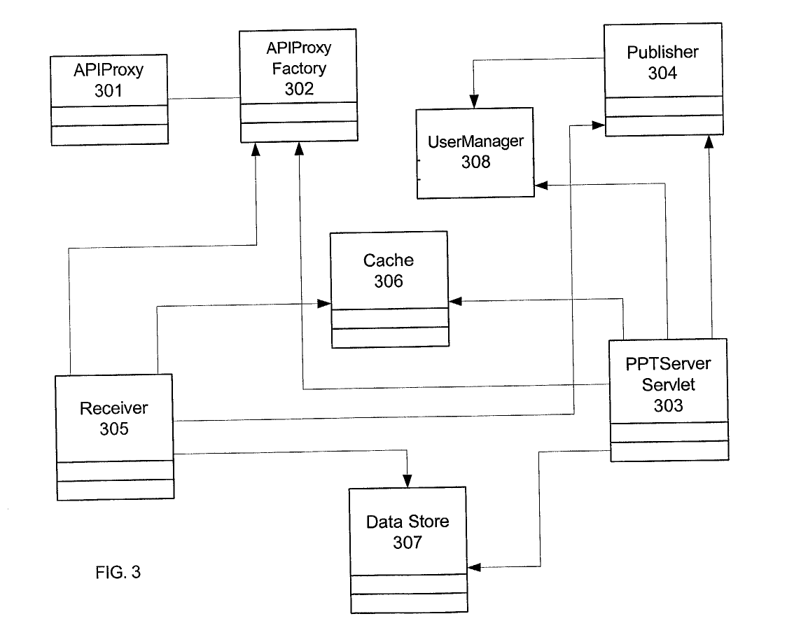

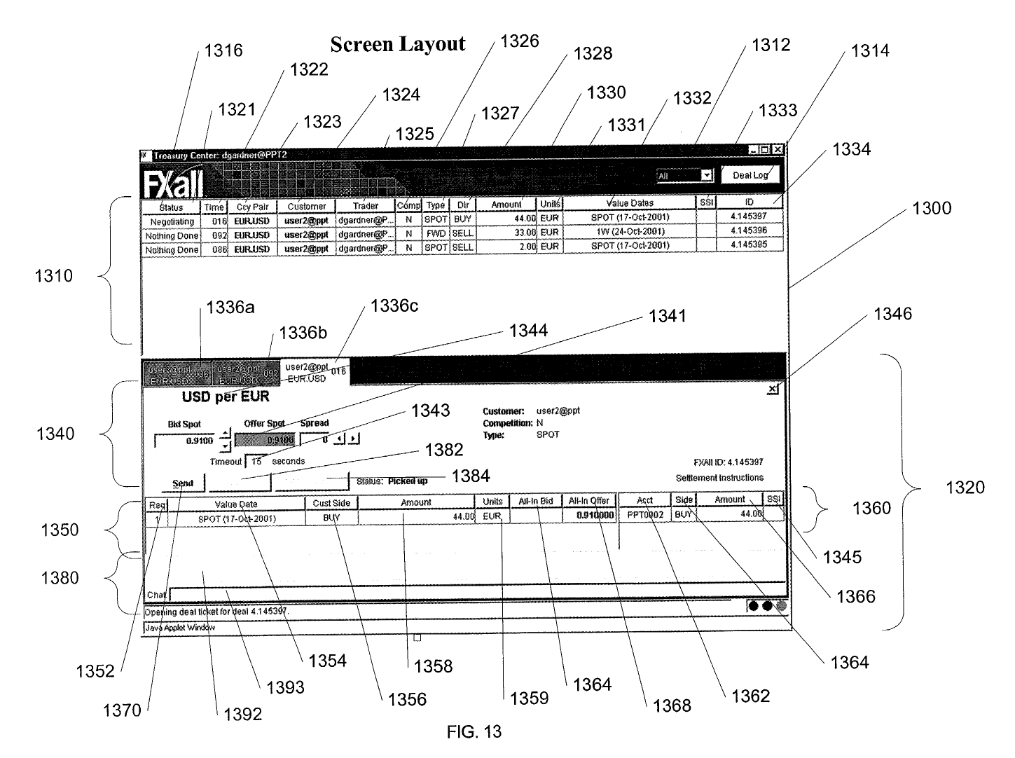

Providers, on the other hand, in at least one embodiment of the invention, download and launch a different applet, hereinafter called “the PPT Applet,” from a PPT Server via a JAVA plug-in. After the PPT Applet is downloaded to a Provider's system, Providers log into the PPT Applet and, via a customizable graphical user interface, review and respond to solicitations, such as RFQs and amendments, submitted by Customers. Providers respond to the solicitations, for example, with either a quote, re-quote, withdraw or abort signal, by entering commands on the PPT Applet running in the Java plug-in. Completed deals are displayed on the Provider's onscreen blotters (described in detail below with reference to FIGS. 13, 14 and 15) and recorded in a transaction status database (described below with reference to FIG. 3). The PPT Applet transmits the Provider's responses to the PPT Server (preferably using HTTP tunneling via the Internet or leased lines), which then sends the responses to the Customer.

An embodiment also includes a transaction server configured to interact with the transaction tool applet or amendment tool interface used by Customers, and with custom provider client applications being used by Providers who have elected not to use the PPT Applet. The interaction is accomplished via the set of library routines and function calls incorporated into the Provider Transaction API. Providers launch the Provider Transaction API application instead of a PPT Applet, to receive solicitations, amendments and rate information, and to provide price quotes to customers via automatic communications with the transaction server and the PPT Server. Preferably, communications with the PPT Server is accomplished via an API Server application residing at or coupled to the PPT Server. In a preferred embodiment, all communication is also encrypted and asynchronous.

IV. Detailed Architecture Description

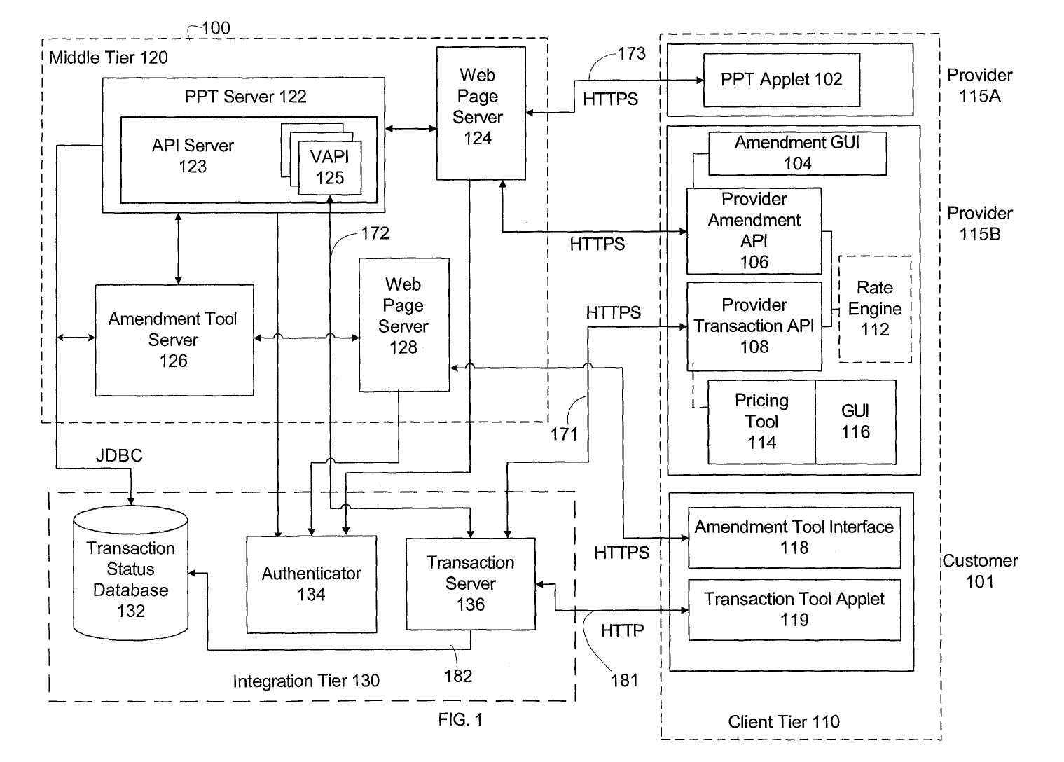

FIG. 1 shows a high-level block diagram of a system configured to operate according to the embodiment of the present invention, as just described above. As shown in FIG. 1, the system 100 comprises a Client Tier 110, which contains the applets and customized application programs Customers and Providers use to communicate with other components of the system, a Middle Tier 120, which contains the servers for the provider pricing tool and the above-referenced amendment tool, and an Integration Tier 130, which provides database, authentication and transaction server functionality.

Using a standard Internet browser, Customer 101 logs into Amendment Tool Server 126 or Transaction Server 136 and downloads Amendment Tool Interface 118 or Transaction Tool Applet 119. Customer 101 may also opt to use his own trading application (not shown in FIG. 1), instead of Amendment Tool Interface 118 or Transaction Tool Applet 119, which may be configured to interface directly with Transaction Server 136 according to a specified protocol. Customer 101 may also decide to type or import proposed transactions, transaction details or amendments directly into Amendment Tool Server 126 or Transaction Server 136 without downloading one of these applets. In any case, Transaction Server 136 receives solicitations from Customer 101 and sends those solicitations directly to a Provider system (if the provider uses a Provider Transaction API), or to API Server 123 at the Provider Pricing Tool Server 122 (if the Provider uses the PPT Applet).

In a preferred embodiment, Transaction Server 136 is configured to receive both transaction requests from Customers, which it sends to Providers as described below, and responses to solicitations and confirmations from Providers, and pass that information back to the Customers. Transaction Server 136 may also be configured to receive indicative market rates from another source, and provide such rates to the Providers along with the solicitations.

A Provider may download and use PPT Applet 102 to receive and respond to solicitations, or, alternatively, may build or write his own solicitation-monitoring program using the set of library routines configured to interact with Transaction Server 136. As shown in FIG. 1, for example, Provider 115A uses PPT Applet 102 to receive and respond to solicitations, while Provider 115B uses Provider Transaction API 108 or Provider Amendment API 106 for the same purpose. If the Provider uses an applet, an API Server 123, which is coupled to or resides in PPT Server 122, establishes a “virtual” API client (depicted as VAPI 125 in FIG. 1) for that Provider, which is configured to communicate with Transaction Server 136, as if it were running at the Provider's location instead of on PPT Server 122. From the perspective of Transaction Server 136, however, the VAPI 125 acts just like the client Provider Transaction API 108. Thus, Transaction Server 136 can be advantageously configured to use the same communication protocol to interface with different Providers irrespective of whether the Providers use applets downloaded from PPT Server 122 or their own Provider Transaction APIs.

When Provider 115A connects to the system by launching PPT Applet 102, and Provider 115B connects to the system by launching Provider Transaction API 108, Transaction Server 136 receives signals from API Server 123 and Provider Transaction API 108, respectively, indicating that Providers 115A and 115B are both present and accepting solicitations. If the Transaction Server 136 then receives a solicitation bound for Provider 115B, it sends the solicitation directly to Provider Transaction API 108 via link 171 using Hypertext Transfer Protocol over Secure Socket Layer (“HTTPS” or “HTTP over SSL”). (HTTPS is a Web communications protocol that encrypts and decrypts user page requests, as well as the pages that are returned by a Web server in response to the requests). If the solicitation is also bound for Provider 115A (one of the advantages of the system being that solicitations may be sent to multiple banks), then Transaction Server 136 is also configured to use link 172 to send the solicitation to API Server 123 and VAPI 125 in PPT Server 122. As stated above, API Server 123 and VAPI 125, from the perspective of Transaction Server 136, operate in the same manner as Provider Transaction API 108, and therefore they appear to Transaction Server 136 to be a transaction API running on the Provider's system, just like Provider Transaction API 108. From the API Server 123, the solicitation is then sent out to PPT Applet 102 via Web Page Server 124 and HTTPS-enabled link 173.

If the solicitation is an RFQ, Transaction Server 136 may be configured to receive current rate information (i.e., indicative price quotes) from a separate rate feed or database (not shown in FIG. 1) and send that information to each Provider along with the solicitation. Alternatively, Providers may obtain current rate information from a separate rate engine (shown as Rate Engine 112 in FIG. 1, for example). As described in more detail below with reference to FIG. 13, PPT Applet 102 may be configured to provide users with, among other things, visual and/or audible alerts indicating that a new solicitation has arrived, the ability to view the solicitation on multiple workstations and lock the solicitation after it is selected for dealing, as well as certain sorting, filtering and price adjustment functionality, all designed to improve the Provider's ability to review solicitations and provide prompt responses.

Provider 115A, Provider 115B, or both of them, may respond to the solicitation by entering a price quote (in the case of an RFQ) or an acceptance or rejection (in the case of a request to amend a previously submitted transaction) into their respective client programs. In the case of Provider 115B, who has built its own interface to Transaction Server 136, the price quote may be obtained by the user from a separate and optional Pricing Tool 114 built or purchased by the Provider. The Pricing Tool 114 may also include an optional customized graphical user interface (shown as Pricing GUI 116 in FIG. 1) designed to accommodate specific dealing or trading requirements of the Provider. Whatever the Provider's response, and from whatever source it is derived, it is subsequently sent back to Transaction Server 136 via API Server 123 for Provider 115A and via Provider Transaction API 108 for Provider 115B. Transaction Server 136 then sends the response back to Customer 101 via HTTP-enabled link 181 and either Amendment Tool Interface 118 or Transaction Tool Applet 119. Notably, Transaction Server 136 may also be configured in some embodiments to send the solicitation to one or more Providers again (or to an alternative set of Providers) if the Providers who receive the original solicitation fail to respond within a specified period of time or fail to respond at all.

As shown in FIG. 1, the system may also include a Transaction Status Database 132 (or multiple transaction status databases), which may be coupled to Transaction Server 136 and PPT Server 122 via link 182, and which is configured to record the transaction details of pending and/or completed transactions, as well as a current status for each such transaction (such as whether the transaction is currently locked by a user). In a preferred embodiment, Transaction Status Database 132 is updated in real time each time a transaction status-changing event takes place in the system. In addition, PPT Server 122 can be configured to communicate with Transaction Status Database 132 using the Java Database Connectivity (JDBC) protocol, which is an application program interface (API) specification for connecting programs written in Java to the data in popular databases. JDBC provides the ability to encode database access request statements in Structured Query Language (SQL) that are then passed to a program that manages the database.

The present invention may also include an authentication and entitlement component (shown in FIG. 1 as Authenticator 134) or multiple authentication and entitlement components (not shown in FIG. 1), which determine whether a user can log on more than once, whether a user can log on at all, and/or what actions the user can perform once logged on. In a preferred embodiment, Authenticator 134 is configured, for instance, to determine user permissions and entitlements based on a “role” to which the user has been assigned. Provider bank employees who have been assigned the roles of “Dealers” or “Traders,” for example, may have access to certain functions, or may be authorized to execute and/or confirm certain transactions that are not the same as the functions and transactions available to employees assigned to other roles, such as “account manager” or “middle office worker.” Authenticator 134 may also be configured to operate in conjunction with a lightweight directory access protocol (LDAP) directory, as is known in the art, which specifies the logical locations within a data communications network where certain individuals, organizations and resources may be found.

Web Page Servers 124 and 128 in FIG. 1 use the client/server model and HTTP, as is known in the art, to send the files that form Web pages to the Provider and Customer client applications (whose computers contain HTTP clients that forward their requests). Every computer on the Internet that contains a Web site must have such a Web server program.

As stated above, the provider pricing tool of the present invention may be configured to respond to solicitations submitted by Customer 101 comprising requests to amend previously submitted transactions. Such amendments may be submitted by Customer 101 using Amendment Tool Interface 118, received by the Provider using a customized Provider Amendment API 106, and processed in Middle Tier 120 by Amendment Tool Server 126, all of which are shown in FIG. 1 to provide a more comprehensive illustration of the various functions and options that may be implemented in systems configured to operate in accordance with embodiments of the invention. Provider Amendment API 106 may also be configured to operate in conjunction with a customized graphical user interface for responding to amendments (depicted as Amendment GUI 104 in FIG. 1). These and other components that operate to provide a way for Customers and Providers to conduct transactions comprising amendment requests are described in more detail below and in co-pending application Ser. No. ______, entitled, “METHOD AND APPARATUS FOR AMENDING FINANCIAL TRANSACTIONS.”

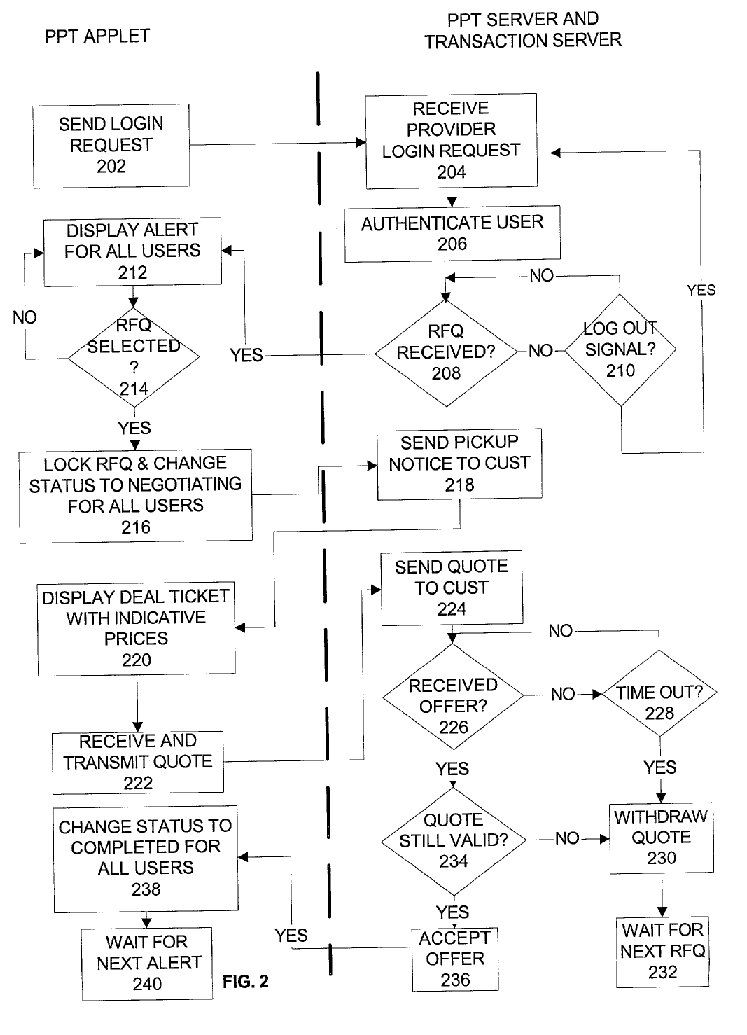

FIG. 2 contains a very high-level flow diagram illustrating the steps performed in an embodiment of the present invention by PPT Applet 102 on the one hand (the left side of FIG. 2), and by PPT Server 122 and Transaction Server 136, on the other hand (the right side of FIG. 2). First, in step 202, Provider PPT Applet 102 sends a login request to PPT Server 122. PPT Server 122 receives the login request, at step 204, and, preferably verifies whether the user has authority to log on, step 206, via Authenticator 134. In a preferred embodiment, a message is sent to Transaction Server 136 indicating that the Provider is logged on and ready to start receiving RFQs. Next, in step 208, Transaction Server 136 determines whether an RFQ has been received for the Provider. If not, then the system checks, at step 210, to see whether the Provider has logged out. If the Provider has not logged out, then Transaction Server 136 goes back to waiting for an RFQ to come in for the provider.

If, on the other hand, an RFQ for the Provider has been received, then, in step 212, PPT Applet 102 presents an alert on the workstations of all users at the Provider. Next, at step 214, PPT Applet 102 determines whether the RFQ has been selected for dealing. If the RFQ has not been selected for dealing, then control passes back to step 212, where PPT Applet 102 continues to present alerts on the workstations of all users. If the RFQ has been selected, the PPT Applet 102 locks the RFQ to prevent other dealers from selecting it to deal (as shown in step 216 of FIG. 2), and preferably updates a transaction status record in a database to indicate that the RFQ is now in the “Negotiating” Status.

In a preferred embodiment, and as shown at step 218 of FIG. 2, a “pick up” notification is then sent to the Customer indicating that a dealer has selected the solicitation for dealing. Then, in step 220, PPT Applet 102 displays to the dealer a deal ticket that is seeded with indicative price quotes. At step 222, PPT Applet 102 receives input from the dealer comprising a price quote, and, preferably, a timeout value specifying the amount of time the Customer will have to respond to the price quote before it expires, both of which the PPT Applet sends back to PPT Server 122. Notably, the dealer may choose to use one of the seeded price quotes provided by the system, or he may choose to use a different quote, depending on a variety of factors, such as the current state of the particular market. In the next step, step 224, the price quote is sent to the Customer.

As illustrated by step 226 in FIG. 2, the system next determines whether an offer to deal responsive the price quote has been received. If not, the system determines, at step 228, whether the specified timeout has been triggered because the Customer did not provide a response within the time limit set by the Provider. If the elapsed time exceeds the timeout limitation set by the Provider, then the system withdraws the quote (step 230), sends the Customer a withdrawal notice (not shown in FIG. 2), and then waits for the next RFQ (step 232) to come in.

If, however, the system determines, at step 226, that an offer to deal has been received, it next determines, at step 234, whether the quote is still valid. A quote may become invalid, for example, because the customer waited too long to provide a response or the dealer simply changed her mind about the quote, and has therefore sent a signal to the system instructing the system to withdraw the quote. If the quote is not still valid, control again passes to step 230, where the quote is withdrawn from the Customer. But if the quote is still valid, the system automatically accepts the offer to deal, step 236. Upon acceptance of the offer to deal, PPT Applet 102, at step 238, changes the status of the RFQ to “Completed” for all users at the Provider. Finally, as shown in step 240, PPT Applet 102 waits for the next alert to come in.

Notably, the steps performed in FIG. 2 may be beneficially applied to FX transactions or any number of other types of financial transactions, including but not limited to stock and money market transactions, for example.

A. Implementation Considerations

Embodiments of the present invention may be implemented using: Java 2 SDK, Standard Edition, v 1.3 and Java Plug-in, v 1.3.x, available from Sun Microsystems Corporation of Mountain View, Calif. (www.sun.com); JTIWeb from Random Walk, Inc., of New York, N.Y. (www.randomwalk.com); JRun Server 3.1 Professional Edition, available from Macromedia, Inc. of San Francisco, Calif. (www.macromedia.com); Web Server 4.0, available from IPlanet, a division of Sun Microsystems; Data Server 8.1.7 and JDBC Thin drivers from Oracle Corporation of Redwood Shores, Calif. (www.oracle.com); and Internet Explorer 5.x and 6.0, available from Microsoft Corporation of Redmond, Wash. (www.microsoft.com). However, upon reading this disclosure and practicing the claimed invention, those of skill in the art will recognize and appreciate that the invention may be implemented equally as well using as components the products and services of other companies, which have the same or similar features. Therefore, the detailed descriptions herein of specific implementations of the invention are intended merely to illustrate its principles, but not to limit its scope.

B. PPT Applet

The PPT Applet described in more detail below, runs within a Java Plug-in. The Java Plug-in enables applets to execute in Sun Microsystem's Java 2 Runtime Environment, Standard Edition (JRE) instead of a Web browser's default virtual machine. The Java Plug-in is typically more reliable and consistent than the default Java Virtual Machine implementations found in most Web browsers.

1. User Interface

In a preferred embodiment, the PPT Applet 102 may be configured to use a graphical user interface (GUI) compatible with Microsoft Windows® so that all GUI controls resemble their native Windows counterparts and look natural and familiar to a Windows user. This type of user interface may be implemented regardless of the operating system hosting the PPT applet.

2. Asynchronous Messaging

All messages sent from PPT Applet 102 are transmitted serially and asynchronously to PPT Server 122. Messages are sent serially to prevent out of order message reception on the server. Additionally, messages are sent asynchronously to prevent the application from blocking the user interface while the message is sent over the network. Once the message is sent and/or a timeout occurs, a callback method is used to inform PPT Applet 102 of the result of the sent message and any return values (including Java exceptions). Sending messages asynchronously ensures that the GUI stays responsive, even under poor network conditions.

3. Connection State

PPT Applet 102 maintains a logical connection to PPT Server 122 through a Java framework, called JTIWeb, available from Random Walk Computing, Inc., of New York, N.Y. (www.randomwalk.com). If JTIWeb reports, through a JTIWebAdminMessage, that the connection has been lost, PPT Applet 102 is disabled and the user is informed of the problem through various feedback mechanisms. When JTIWeb indicates that the connection has been restored, PPT Applet 102 returns to its normal state.

a. Message Send Failure

All messages sent by the PPT Applet to PPT Server 102 include an instance of the JTIWeb MethodFinishedCallback class. This class reports whether execution completed successfully or an exception was thrown on the server. In the latter case, PPT Applet 102 uses the type of exception and its message to determine what feedback to present to the user. This may include a traffic light indication, informational dialog, and/or status bar message.

b. Error Conditions

Various error conditions may occur on PPT Server 122 during or independent of a particular synchronous call from PPT Applet 102. These errors are reported to the PPT Applet 102 in the same manner as with all other asynchronous server-to-client messages, and are identified via the subject PushSubject.ADMIN. The error message contains a ServerStatus object. The ServerStatus object identifies the specific error. PPT Applet 102 uses this information to provide feedback to the user. Feedback may also include a traffic light indication, informational dialog, and/or status bar message.

4. Applet Deal Completion

In order to give PPT Applet 102 maximum control over the deal completion, the response to a deal request message is determined at PPT Applet 102. The deal request message contains an FXOrder object, which is an instance of a message containing the details of the deal. The FXOrder object represents the exact deal that the customer has proposed. The price in this FXOrder must match the applet's most recent quoted price and the quoted price must not have been withdrawn. PPT Applet 102 responds with a Deal Accept signal if these checks pass and sends a Deal Reject signal otherwise.

As an extra safeguard against accepting a stale price, PPT Server 102 will automatically send a Deal Reject to a Deal Request that has been outstanding for a specified period of time on the server. This might occur, for example, when there is a communication problem between PPT Applet 102 and PPT Server 122.

5. Deployment of the PPT Applet to a Provider Bank

The PPT Applet 102 is deployed to the Provider client machine as a Java applet using the Java Plug-in. The applet is embedded in an HTML page accessible from a public Web server. The user accesses the Web page using a standard browser, such as a Netscape Navigator or Internet Explorer, and standard hypertext transfer protocol (“HTTP”). The Plug-in installed on the provider client machine then runs the applet, and the PPT Applet 102 appears in a separate window independent of the web page. In some embodiments, the web page must be kept open while the PPT Applet 102 is in use.

C. PPT Server/Applet Communication and Error Handling

1. Server Push

To be compatible with standard web browsers, communications between the PPT Applet 102 and the PPT Server 122 must take place over HTTP. Moreover, in a preferred embodiment, PPT Server 122 must send messages and data to PPT Applet 102 asynchronously and without a specific request from PPT Applet 102 to do so. This process is known as “server push.” But HTTP is designed as a request-response protocol, meaning that the client must initiate all connections. In other words, HTTP does not allow a server to initiate a transaction with a client (pushing data out to it). So when the server, for example, receives a status change it cannot open a connection to notify the client of the new data—especially when there are corporate firewalls and proxies involved.

Although equally suitable products, such as Weblogic™ Server (available from BEA Systems, Inc., of San Jose, Calif.) may be used for this purpose, embodiments of the present invention overcome these server push obstacles by utilizing Random Walk's JTIWeb framework. Among other things, the JTI framework achieves server push by using multiple connections between a Java applet client tier and a Java Servlet middle tier. When a client enters the system, a JTIWeb Servlet sets up session information for that user connection, but does not send back a response, thereby establishing a “persistent” open connection with the client. Subsequently, when the user makes various requests, such as submitting an order, subscribing to market data, etc., these requests are sent to the server using new HTTP connections. Upon receiving a new request, the JTIWeb Servlet looks up the user making the request and flushes request results (market data, status updates, etc.) across the original persistent open connection and the new connection with the client is never allowed to close. Thus, there is always at least one open connection to the client.

There is a risk associated with maintaining an open HTTP connection for potentially long periods of time. The Internet, including the various proxy servers an Internet connection uses, does not expect long-standing open connections, and therefore may arbitrarily close it. The JTIWeb Servlet and client, therefore, is configured to actively monitor the connection to verify that it has not been lost. If the connection is closed, the client automatically logs in again, reestablishing a connection. This monitoring is achieved by the use of regular “heartbeat” messages from the server to the client at specified intervals.

2. Serialized Objects

In a preferred embodiment, all messages sent between the client and server are serialized Java objects tunneled through the HTTP protocol. Java serialization provides an easy and straightforward mechanism for transmitting objects from one Java Virtual Machine (JVM) to another.

3. Security—SSL, TripleDES

A preferred security model for the present invention is for the PPT Applet 102 to open an SSL connection with Web Server 124, negotiate a cipher protocol and a secret key (as in any SSL session) and then have the server generate a separate TripleDES session key that is passed to the client over the SSL connection. The client uses this session key and the server to encrypt all data sent over regular HTTP connections. The web browser does not intercept this channel (as with SSL), so the data is only decrypted at the application level by the applet and the JTIWeb Servlet.

4. Error Conditions

As stated above, the JTIWeb framework may be configured to use heartbeats to verify that clients are still connected. If a heartbeat fails, it attempts to reconnect several times. If not successful, the client session information is removed and the user must log in again. the JTIWeb framework assigns a message sequence number to each message it pushes to each client, per subject. The client code keeps track of the previous sequence number and can detect if one or more messages have been missed. If so, it notifies PPT Applet 102 of the missed message.

For each call made to the server by the applet, the following checks are made in order. As stated above, in this embodiment, the JTIWeb framework is used to transport any errors or exceptions to the PPT Applet client.

a) If the client no longer has a valid session on the server, a SessionExpiredException is thrown. This might occur, for example, if the client has been booted out via the Admin, and the client makes a call to the server before the forced_logout message has reached the client.

b) If the call accesses functionality that only a trader is allowed to execute, but the user is marked as being a middle office user, then an AccessViolationException is thrown. Preferably, PPT Applet 102 ensures that a user logging in as a middle office user cannot access trader functionality, so this scenario can happen only if there is a coding bug in the client, or if the client has been compromised.

c) If the server is currently down, a ServerUnavailable Exception is thrown. If the connection for a particular provider is down, the server is marked as being unavailable for the clients of that provider. Also, if the database connection is down, the server is marked as being unavailable for all clients.

d) If the call refers to an order (by orderID) which cannot be located in the server caches, an OrderNotFoundException is thrown. This can happen if the client sends a WithdrawQuote message for an order, the customer simultaneously sends a Nothing_Done, and the Nothing_Done reaches the server first. In this case, the server will remove the order on getting the Nothing_Done, and later throw an OrderNotFoundException on receiving the WithdrawQuote call from the client.

e) If the call results in a corresponding call being made to the API Library, and the API Library returns a false, an API exception error is generated.

f) If the call results in a query or update to the database, and the database throws an SQLException, then a DatabaseException is thrown.

g) If the server detects a generic exception while executing the call, it wraps the exception in an InternalServerException and throws it to the client.

The PPT Applet client may encounter two major categories of communication errors: synchronous errors (in response to a message to the server) and asynchronous errors (reported without any action by the client).

a. Synchronous Error Messages

In a preferred embodiment, the following synchronous error messages are defined in the PPT Server interface:

LoginResult login(String traderId, char[ ] password) throws PPTServerException;

void logout( ) throws PPTServerException;

void quote(FXOrder order) throws PPTServerException;

void withdrawQuote(String orderID, String reason) throws PPTServerException;

void withdrawQuotes(String[ ] orderIDs, String reason) throws PPTServerException;

void abortQuote(String orderID, String reason) throws PPTServerException;

void acceptDeal(Fxorder order, String condition) throws PPTServerException;

void rejectDeal(FXOrder order, String reason) throws PPTServerException;

void sendChatMessage(String orderID, String message) throws PPTServerException;

boolean requestLock(String orderID) throws PPTServerException;

void startSearch(SearchCriteria criteria) throws PPTServerException;

PasswordChangeResult changePassword(String traderID, char[ ] oldPassword,

char[ ] newPassword) throws PPTServerException;

Three messages (Login, Request Lock and ChangePassword) have specific return values, which can indicate success or operation-specific errors. The other messages (those with no return type) are considered successful if they return without an exception.

b. Asynchronous Error Messages

As stated above, preferred embodiments of the present invention are configured, using the JTIWeb framework or similar product, for example, so that the server can push messages to the client asynchronously. When the JTIWeb framework is used, PPT Applet 102 receives asynchronous error messages from PPT Server 122 via a client-side JTIWeb framework layer. The JTIWeb framework also reports connection errors by simulating an asynchronous message, using the subject JTIWebMessages.ADMIN_SUBJECT. A PushSubject.SERVER_STATUS message contains a ServerStatus object indicating the current status, either ServerStatus.SERVER_UP or ServerStatus.SERVER_DOWN.

When the current status is ServerStatus.SERVER_DOWN, the status bar displays a brief error, with red background, stating that the server is experiencing problems. The traffic light switches to red. A modal dialog appears, stating that the server is temporarily unavailable. A button on the dialog allows the user to quit the PPT Applet and return to the login page. For a trader, the Active Deals Blotter (described below with reference to FIG. 3) is cleared and any open Deal Tickets are closed. When the current status is ServerStatus.SERVER_UP, the status bar displays a message stating that the server is back to normal, and the traffic light becomes green. The error dialog disappears.

A JTIWebMessages.ADMIN_SUBJECT can be one of the following:

1) JTIWebAdminMessage.RECONNECTING: The status bar displays a message indicating that the connection has been temporarily lost, and the client is trying to recover. In this case, a traffic light on the users screen becomes yellow to indicate that there is a problem.

2) JTIWebAdminMessage.CONNECTION_LOST: The status bar displays a message on a red background indicating that the connection has been lost. When this happens, the traffic light switches to red. A modal dialog appears, stating that the connection has been lost and the client will try to reconnect. A button on the dialog allows the user to quit PPT and return to the login page. For a trader, the ActiveDealsBlotter is cleared and any open DealTickets are closed.

3) JTIWebAdminMessage.MESSAGE_MISSED or JTIWebAdminMessage.MESSAGE_NOT_SENT: A message is displayed on the status bar. The traffic light blinks red a few times and then returns to its previous state.

4) JTIWebAdminMessage.CONNECTION_ESTABLISHED: The user is logged out, and the login panel reappears.

D. PPT Server

PPT Server 122 contains business rules for and runs as a single JAVA virtual machine (JVM) to support any number of provider banks. A single JVM server system usually provides better performance and fewer production support problems than a system using multiple JVMs. The server comprises a set of Java Servlets running within a standard Java Servlet engine and responds to HTTP requests from PPT Applets.

1. User Authentication

When a user attempts to login to PPT Server 122, PPT Server 122 will call an authentication and entitlement component (shown as Authenticator 134 in FIG. 1), which will return the result of the login request and the user's entitlements. In a preferred embodiment, PPT Server 122 and Authenticator 134 are configured to check the user's entitlements on each request. The first call a PPT Applet 102 makes to the server is login( ). Authenticator 134, which may reside on the same physical machine as the PPT Server 122, maintains a UserManager class, which keeps track of users who are currently logged in. The Servlet denies the login attempt if the UserManager reports that the user is already logged in. Users are removed from the currently logged-in list when the client calls the logout method on the Servlet or when JTIWeb notifies the Servlet that the client was disconnected.

2. Provider Login

When PPT Server 122 starts, it reads a list of providers and provider passwords from a database table containing information about transaction counterparties. PPT Server 122 is capable of loading new providers at runtime. If a user logs in with a provider that is not listed in the provider database table, the user login is denied. If the provider is added to the provider list, the provider is logged on to PPT Server 122 and the user is notified asynchronously. If PPT Server 122 loses a connection for any Provider, PPT Server 122 starts a background thread that attempts to login the Provider every N seconds, where N is configurable in a properties file. If a user from this Provider logs in before reconnection has been established, he will receive an error and will be notified when connection is reestablished.

3. PPT Server Servlet

A Java interface defines the calls that the PPT applet can make to the PPT server. The JTIWeb framework provides a compile tool, which takes this interface class as input, and outputs a stub class for the client to use, and an abstract Servlet class for the PPT Server to implement. At runtime, the JTIWeb framework routes the calls from the PPT applet to methods within the PPT server's Servlet.

4. Multiple Provider API Connections

The API library uses static variables to store connection state, which normally allows only one connection per JVM. However, PPT Server 122 can be configured to support many providers simultaneously in a single JVM. Therefore, PPT Server 122 must have a mechanism for loading separate versions of the API classes simultaneously. One such mechanism in the Java platform is a ClassLoader. ClassLoaders are responsible for retrieving and loading classes into the JVM.

A class is identified in a Java virtual machine by its name, including package, and the ClassLoader that loaded it. Therefore, classes loaded by different ClassLoaders are effectively separated. The use of custom ClassLoaders allows multiple API connections to run concurrently in one JVM, thereby allowing a single instance of the PPT server to host many separate connections via the API library.

5. Major Classes

The system of the present invention defines eight major classes of entry points for the server. FIG. 3 contains a diagram showing the relationship between the eight major classes. APIProxy 301 interfaces with the API Library and provides methods to send messages to Transaction Server 136. APIProxyFactory 302 creates and maintains one APIProxy per provider and loads providers on the fly if necessary. PPTServerServlet 303 interfaces with JTIWeb library and provides methods for the PPT Applets to call. It also contains the business logic for handling Quotes, Deal Acceptance signals, etc. This class is the Servlet entry point of the server application and it creates the rest of the classes.

Publisher 304 provides methods for sending messages to PPT Applets. Messages addressed to a provider are distributed to all clients currently logged in under that Provider. The Receiver 305 class handles callbacks from the API Library. It contains the business logic for handling RFQs, Deal Requests, etc. For example, on receiving an RFQ, Receiver 305 inserts the RFQ in the Cache, and hands it to Publisher 304 for publishing out to all clients.

Cache 306 stores orders and keeps track of which orders are new RFQs, which have been picked up by traders, etc. Data Store 307 interfaces with a database and handles storing of completed deals, executes queries received from PPT applets, reads in Provider passwords, etc. As stated above, UserManager 308 keeps track of which users are currently logged in and maintains user-lists indexed by a Provider name or I.D.

As stated above, Receiver 305 handles messages received from the API Library. It takes the appropriate action for each message, such as routing them to Publisher 304 for broadcast, saving them in the cache, or responding with a message back to API Library. PPTServerServlet 303 handles messages received from the clients. Based on the method getting called, this class takes appropriate action, such as sending a notification to all traders via Publisher 304, saving order status in the cache, or forwarding the request to the API Library.

6. Data Flow

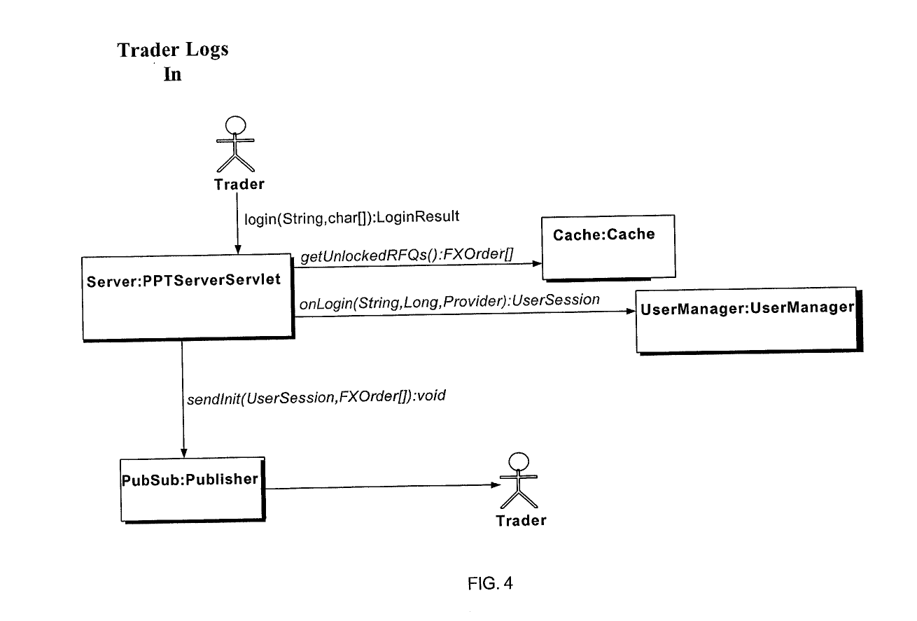

FIGS. 4 through 10, 11A, 11B and 12 illustrate the message flows triggered by the use of certain major entry points in a transaction server configured to operate in accordance with an embodiment of the invention. As an order goes through its various stages from RFQ generation to deal completion, the server selectively stores information about these stages in its cache. The order cache is implemented as a set of Cache objects—one per provider. A single CacheFactory object maintains and provides access to these caches. Below is a breakdown of the various stages in the life of an order with respect to their effect on the cache.

1. Trader Logs In (FIG. 4): At login, all unlocked RFQs currently in the cache are sent to the client for display in its blotter.

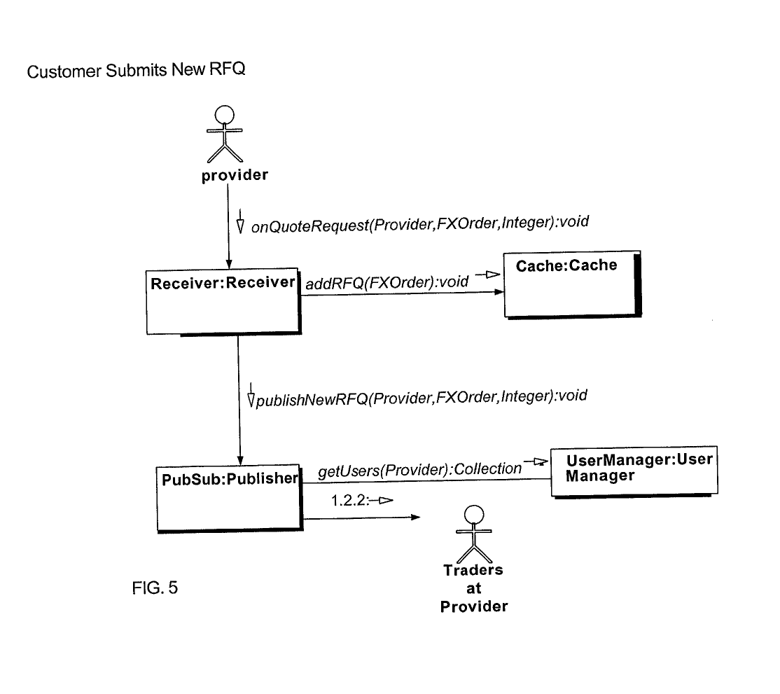

2. Customer submits new RFQ (FIG. 5): The cache stores the order as an unlocked RFQ. This information is useful when a new client logs in.

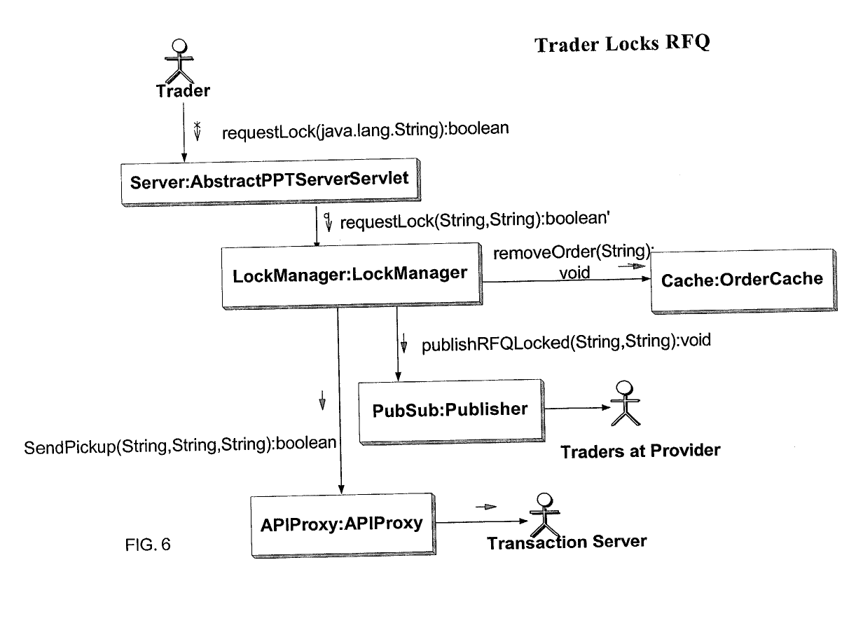

3. Trader Locks RFQ (FIG. 6): When a trader picks up the RFQ, the cache removes the order from its list of unlocked RFQs, and marks it as locked by the trader. The cache maintains a list of locked orders per trader. This is useful when a trader is disconnected or logs out. Upon the occurrence of either of these events, the PPT Server sends an abort quote request to API Server 123 for all quotes currently locked by the trader. When a trader attempts to pick up a trade, a message is sent to PPT Server 122. PPT Server 122 resolves race conditions by synchronizing the lockRFQ method in the Cache object. The one trader who successfully picks up the trade is notified. Other traders who try to pick up the RFQ receive an “RFQ is already locked” message.

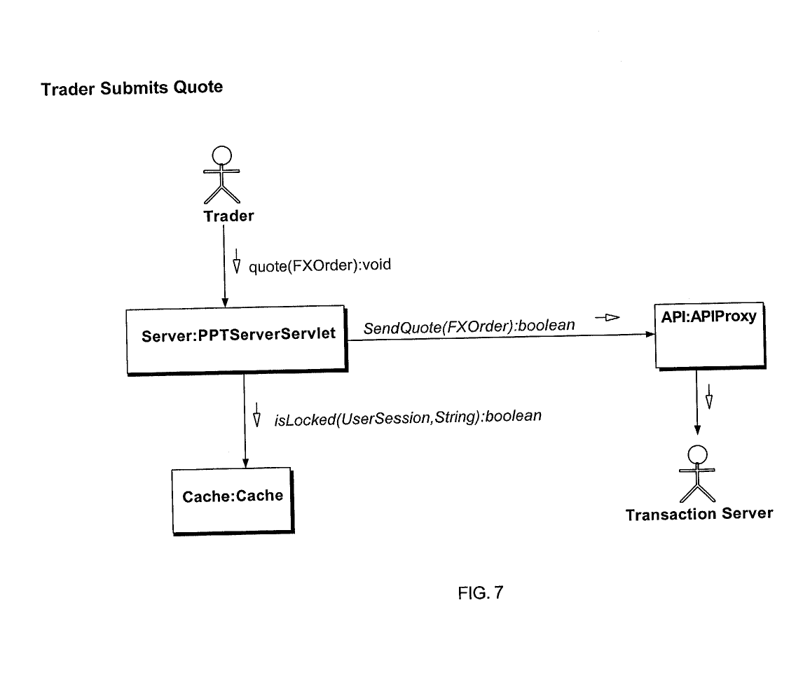

4. Trader Submits Quote (FIG. 7): The cache does not keep track of which orders are being currently quoted.

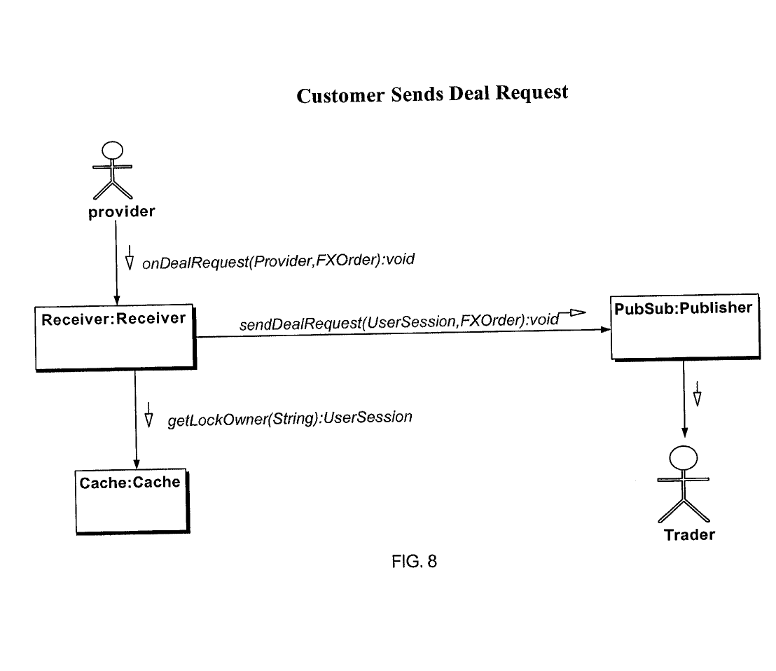

5. Customer Sends Deal Request (FIG. 8): The cache marks the order as being in the Deal Requested state. This is useful if the client (to whom the Deal Request was directed) does not respond with a Deal Accept or Deal Reject within a given time period. In this case, PPT Server 122 sends a Deal Reject to API Server 123.

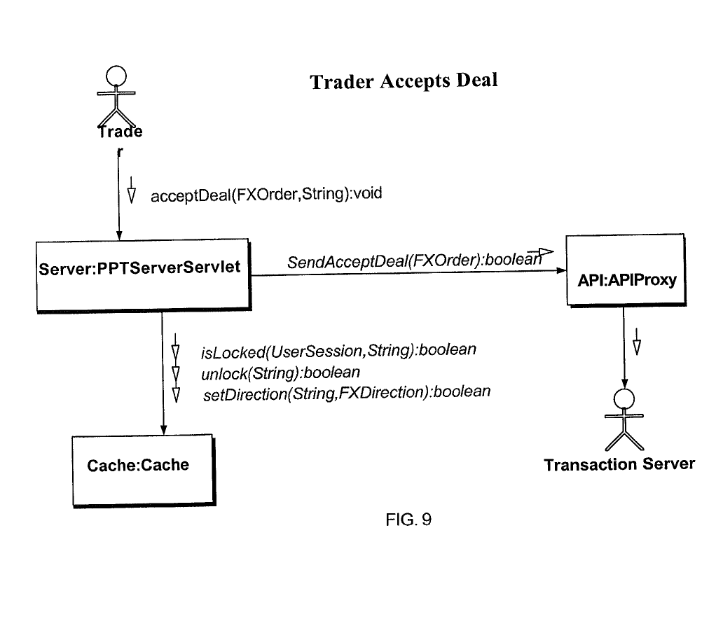

6. Trader Accepts Deal (FIG. 9): The cache removes the order from the list of orders owned by this trader. The cache also stores the direction of the order. The direction is used later when API Server 123 sends a Deal Complete. On receiving a Deal Complete, the PPT Server 122 retrieves from the cache the direction of the order from the cache, and accordingly sends a Completed Buy or Completed Sell message to all the traders.

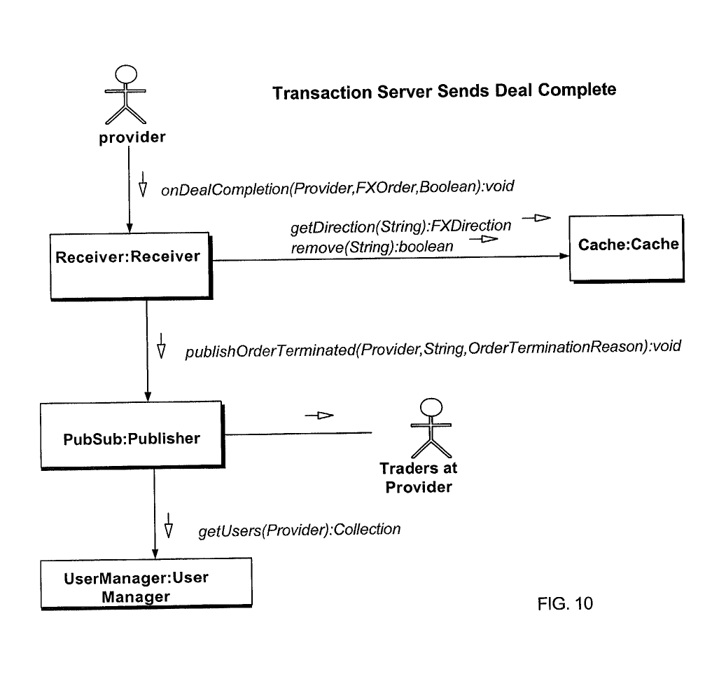

7. Transaction Server 136 Sends Deal Complete Signal (FIG. 10): The direction of the order is retrieved from the cache and either a Completed Buy or Completed Sell is sent to all traders at the Provider. The order is then removed from the cache.

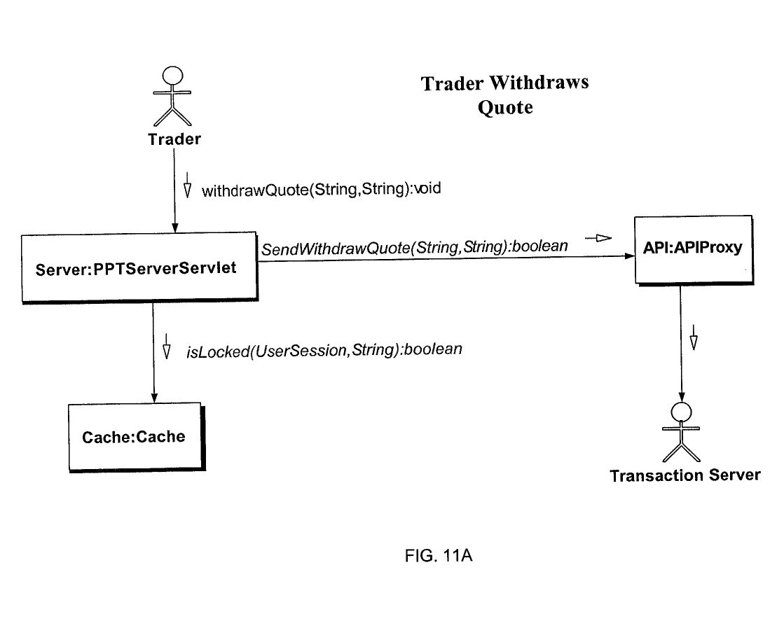

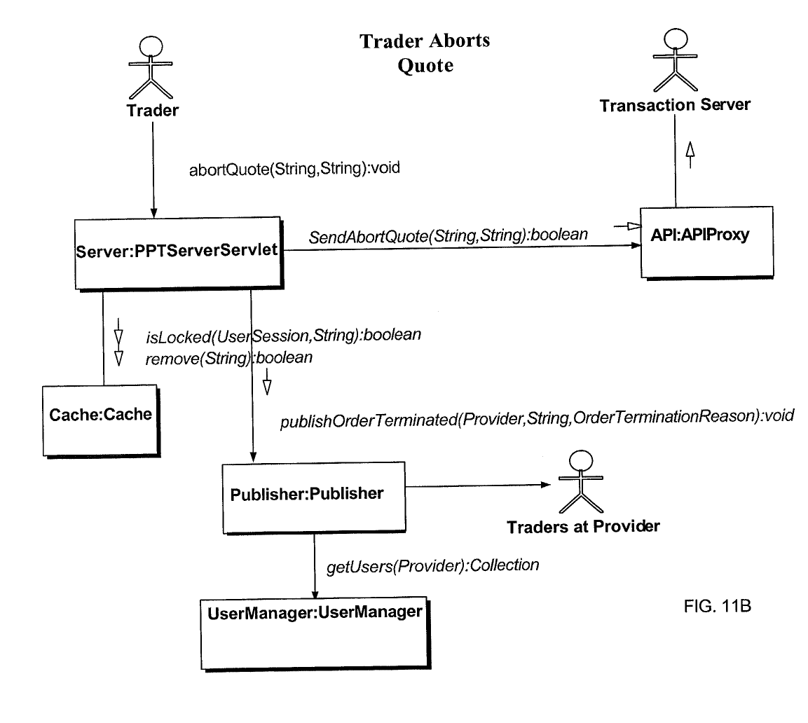

8. Trader Withdraws or Aborts Quote or Rejects Deal Request (FIGS. 11A and 11B): This is called a “terminal condition.” When a terminal condition occurs for an order, the order is immediately removed from the cache.

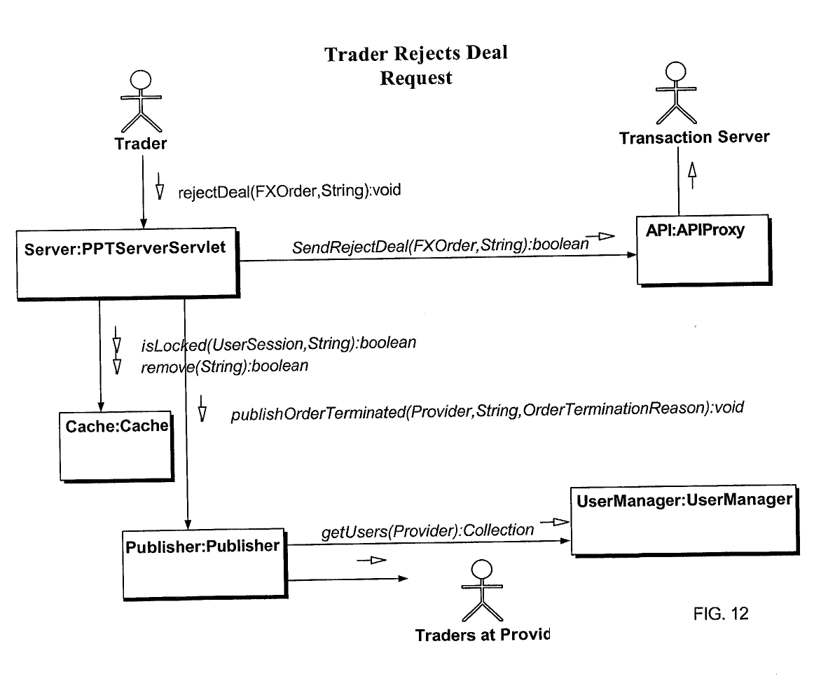

9. Trader Rejects Deal Request (FIG. 12): This is also a terminal condition. When a terminal condition occurs for an order, the order is immediately removed from the cache.

7. Object Translation

In order to isolate objects sent from PPT Applet 102 and to send smaller objects across the Internet, PPT Server 122 translates objects received from PPT Applet 102 to FXOrder objects. FXOrder objects insolate PPT Applet 102 from API Server 123 constants. Translation is bi-directional. The translation is performed in the API Proxy 301 class.

8. Transaction Status Database

a. JDBC Drivers

Oracle provides two types of JDBC database drivers that may be suitably adapted to provide database functionality according to embodiments of the present invention. The thin drivers are implemented entirely in Java and require no additional installation. The native drivers, however, are implemented in C and use Java's JNI interface to call C functions from Java. The native drivers require installation of share libraries on Solaris systems and dynamic link libraries (DLLs) on Microsoft Windows® NT systems. Since there is a small performance difference between the two driver types, either the thin drivers or the native drivers may be preferred, depending on the requirements of the systems where they are used.

b. JDBC Connection Parameters

In a preferred embodiment, PPT Server 122 connects to a database using the JDBC connection parameters shown in Table b 1 below.

TABLE 1
JDBC Connection Parameters

| Name | Sample Value |
|---|---|
| Oradriver | oracle.jdbc.driver.OracleDriver |
| Oraurl | jdbc:oracle:thin:@godzilla:1521:rwora8i |
| Orauser | fxall |
| Orapasswd | fxall |

The Oraurl property should be modified on each installation and has the form:

jdbc:oracle:{DriverType}:@{Hostname}:{Port}:{Database}

c. Reconnection

If the PPT Server 122 database connection fails, it will attempt to reconnect to the database. If the database reconnection attempt does not succeed, a thread will be created to periodically attempt to reconnect to the database and users will be notified that the system is down. Once the connection is reestablished, users will be notified that the system is once is running again.

d. Currency Pair Decimal Display

The number of decimals displayed in a currency pair is dependent on the currency pair. For each currency pair there is a database row indexed by the entry FX.CROSS.{base_currency}.{terms_currency}. PPT Server 122 reads the currency pair table during initialization. The number of rows in this table is proportional to the square of the number of currencies. Since this is a large number and may grow over time, PPT Server 122 attaches the number of decimals to display to the FXOrder object on an RFQ by its currency pair rather than sending all currency pairs to PPT Applet 102.

e. Trade Data Persistence and Deal Log

In the preferred embodiment, all database inserts and updates are done via Oracle stored procedures and functions. Functions are used when the PPT needs to receive the key of the record inserted. Stored procedures are used when no return value is needed.

The table structure of the database matches the hierarchy of the COrder object. Deals are stored one per row in the deal table. Each deal table points to N rows in the leg table. Each row in the leg table points to N rows in the requirements and rate component tables. Each row in the rate component table points to N rows in the settlement details table. Each row in the settlement details table points to N rows in the line table. The entire FXOrder array and its subclasses are returned to the provider applet in one call minimizing delays when deal details are displayed on the PPT applet. The database can also hold data for future amendment requests. For example, in an embodiment, when the user is assembling a post-trade allocation request by uploading allocations from his working blotter, the working blotter shows deals already executed that are in the process of being amended. The deal may appear on the working blotter for one or more of a plurality of reasons, including, for example: (1) At trade time, the Customer indicated that the deal would be subject to amendment (These deals appear in the working blotter as soon as they are executed in a “pending amendment” status); or (2) Even if the Customer didn't indicate at trade time that the deal would be subject to amendment, the Customer has nonetheless submitted an amendment request to the provider (These deals appear in the working blotter with an “amendment in progress” status).

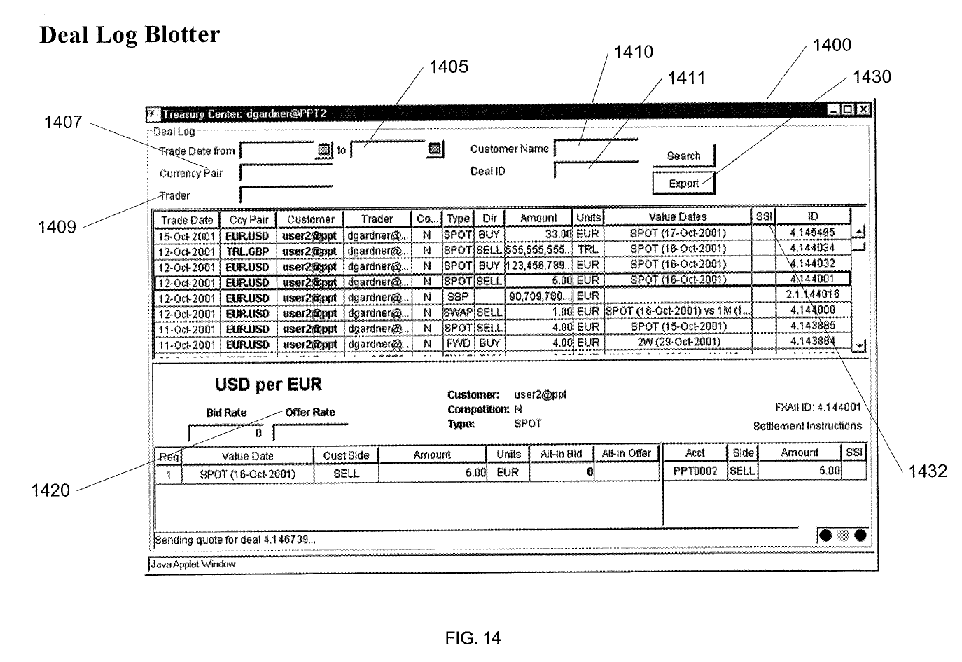

The Deal Log Blotter (described in more detail below with reference to FIG. 14) initiates a deal searching with matching criteria. In addition to the criteria a user selects, the result set will be limited by the user's provider name. The search retrieves rows from the database resembling FXOrder objects. An array of these objects is returned to the PPT Applet 102. The Deal Log Blotter can also export data to a CSV-formatted data stream. PPT Server 122 does not create an intermediate file. The data is displayed in a new browser window and can then be cut and pasted into other Windows applications, such as Microsoft Excel.®

9. Provider Transaction API Connection Parameters

PPT Server 122 reads parameters for a Provider Transaction API connection from a Java property file, ppt.properties, during initialization. As shown in Table 2 below, the property file contains name-value pairs needed for the Provider Transaction API connection. In a preferred embodiment, these values are modified on each installation.

TABLE 2
Provider Transaction API Connection Parameters

| Name | Sample Value | Comment |
|---|---|---|
| api.host | Cartman | SCSLite host |
| api.port | 8088 | SCSLite port |
| api.reconnectPeriod | 20 | Reconnect delay |
| | | (seconds) |
| api.connection | ABC.Counterparty.Connection | API Library |
| | | resource |
| | | connection |

10. Server Logging

Error and status logging for embodiments of the invention may be implemented by using any standard logging utility. One such standard logging utility, “log4j” can be obtained by contacting the Open Source Initiative (OSI) (www.opensource.org). Log4j allows system administrators to enable logging at runtime without modifying the executable binary file for the application. Logging behavior is controlled by editing a configuration file, thereby making it unnecessary to make changes to the application's executable file. With Log4j, logging statements can remain in shipped code without incurring a heavy performance cost. In a preferred embodiment, the log4j logging configuration properties are placed at the end of a PPT Server configuration file. Each of the major class files described above with reference to FIG. 3, for example, is a log4j category that may be specified at the end of the PPT Server configuration file.

Table 3 shows examples of three such log4j properties and their sample values.

TABLE 3
Log4j Properties

| Name | Sample Value |
|---|---|
| log4j.appender.A1.File | ppt.log |
| log4j.category.com.fxall.ppt.APIProxy | DEBUG |
| log4j.category.com.fxall.ppt.Receiver | INFO |

E. Build and Deployment Procedures

The invention may be deployed as a single Web Archive (.WAR) file. Once built, the .WAR file may be deployed in an environment-dependent manner.

1. Web Archive Build Options

There are a number of build options, described below, that may be set up at build time.

a. Encryption Mode

In a preferred embodiment, communication between various servers and client applets is encrypted. The system of the present invention may be configured to use TripleDES encryption, Secured Sockets Layer (SSL) encryption or no encryption. TripleDES encryption is provided by JTIWeb, and SSL by the Web Server or a “servlet” running on the Web Server. The term “secure” refers to either of these types of encryption. Notably, TripleDES encryption requires that an encryption key exchange be carried out through SSL.

b. Signed/Unsigned Client Applet

The build process can generate a trusted (signed) or untrusted client applet. If the encryption mode is TripleDES, the client applet must be signed.

c. Server Port

If TripleDES encryption is used, a TCP port through which the PPT Server communicates with the PPT Applet must be specified. Generally, this will be TCP port 80. If the encryption mode is SSL or unencrypted, the TCP port is specified by the configuration of the Web Server and/or a Servlet Runner.

d. Key Exchange Port

If TripleDES encryption is selected, the TCP port through which the server and client applet exchange encryption keys must be specified. Generally, this will be port 443 (for an SSL key exchange). If the encryption mode is SSL or unencrypted, the TCP port used to exchange the encryption keys is specified by the configuration of the Web Server and/or Servlet Runner.

e. Providers List

The Providers list specifies the set of providers for which the PPT Server will generate valid logins. A name and password is supplied for each provider identified in the list.

f. Database Connection Parameters

In order to connect to the Transaction Status Database, a uniform resource locator (URL) for the database, a username, and a password must be specified.

2. PPT Server Properties Files.

Additionally, miscellaneous default parameters for the PPT Applet, such as colors, delays, applet text messages, version numbers, etc.—may be specified in a ppt_client.properties file. Each of the properties files described below may be edited based on the options determined as described in section A, above.

a. etc/build.properties File

a) secure.build. If the encryption mode is TripleDES, this property should be set to true; otherwise, it should be set to “false.”

b) applet.sign. If the encryption mode is TripleDES, or if a signed client applet is desired for other applications, this property should be set to “true;” otherwise, it should be set to “false.”

b. etc/ppt_client.properties File

This file specifies the colors, delays, and other parameters for the PPT Applet used by a Provider. Preferably, this file is distributed as part of the PPT Applet and the parameters it contains are tailored to the deployment environment. The parameters include, for example:

1) server.serverPort: If TripleDES encryption is used, this property specifies the TCP port through which the server communicates with the client applet. Generally, this will be port 80, the standard http port. This property is ignored if the encryption mode is SSL or unencrypted..

2) server.serverProtocol: This property should be set to “http” if the encryption mode is TripleDES or unencrypted, and “https” if the encryption mode is SSL.

3) server.keyExchangePort: If TripleDES encryption is used, this property specifies the TCP port through which the server and client applet exchange keys. Generally this will be port 443. This property is ignored if the encryption mode is SSL or unencrypted.

4) server.keyExchangeProtocol: This property should be set to “https.”

c. etc/ppt.properties File

This file specifies parameters for the PPT Server application. In a preferred embodiment, the following parameters may be specified in this file:

a) api.host is the hostname or IP address of the API Server.

b) api.port is the TCP port of the API Server.

c) api.connection specifies the Transaction Server Counterparty.Connection parameter.

d) api.reconnectPeriod specifies the delay, in seconds, between attempts to reconnect to the API Server.

e) api.heartbeatInterval specifies the heartbeat interval, in seconds, for the connection to the API Server. This property should be 0 (zero) if connecting through SCSLIte.

f) oradriver specifies the Java class name of the driver for the Transaction Status Database.

g) orauser specifies the username for the Transaction Status Database login.

h) orapasswd specifies the password for the Transaction Status Database login.

i) oraurl specifies the URL of the Transaction Status Database.

j) oraCacheSize specifies the size of the connection pool to the Transaction Status Database.

k) oraMaxRows: specifies the maximum number of rows that can be returned from a Deal Log search.

l) apiProxyFactory.useRobot: must be set to “false.”

d. etc/provider.properties File

This file specifies the providers to which the PPT Server connects. These providers must be in the counterparties table. One provider is listed per line. For each provider, there must be a line with the format:

<provider name>=<provider password>

For example:

PPT1=pp1password

PPT2=pp2password

e. etc/validation.properties File

This file specifies the parameters used to connect to the authentication database.

a) dburl specifies the URL of the authentication database.

b) dbname specifies the usemame used to connect to the authentication database.

c) dbpass specifies the password used to connect to the authentication database.

F. Executing the Build Script

In embodiments, the .WAR file is built through an XML build script interpreted by an Apache ANT system. This application should be installed (see http://jakarta.apache.org/ant), and <ant home>/bin should be in the PATH of the build environment. The JAVA_HOME enviromnent variable should point to an installed Java Development Kit (JDK version 1.3.)

a. Build Only

This build option produces a .WAR file that can be installed in a Servlet container. From a command prompt at the top of the source directory hierarchy, the build script may be invoked with the command “ant war.” The last line of the output from this command will indicate the success or failure of the build. If successful, a file ppt.war will have been created in the same directory.

b. Build and Deploy

This build option builds the .WAR file, and also deploys the application by expanding it to a deployment directory. This option will only work if the Servlet Runner is accessible through the file system.

1) etc/build.properties File

Using a simple text editor, the deploy.dir parameter should be set to the absolute path of the Servlet Container web application directory. This path should follow the file system naming conventions of the build machine, and should not include a trailing slash.

2) Executing the Build Script

The build script may be executed by entering the command: “ant deploy.” The last line of the output from this command will indicate the success or failure of the build. If successful, a file ppt.war will be created in the same directory; a ppt/directory will have been created under a Servlet Container Web application directory; and the .WAR file is expanded into this new directory. If the application is not deployed using the “ant deploy” command, the new application should be deployed through the Servlet Container's web application deploy tool.

G. Encryption-specific Web Server Configuration

If the application is built with the encryption mode set to TripleDES, then the Web Server and/or Servlet Runner should be set to accept HTTPS connections on the port specified by the serverPort property of the ppt_client.properties file, to accept HTTPS connections on the port specified by the keyExchangePort property of the ppt_client.properties file. This will require installation of a certificate. If, on the other hand, the application was built with the encryption mode set to SSL, then the Web Server and/or Servlet Runner must be configured for SSL (configured to accept HTTPS connections). Port 443 is the standard port for SSL, though the application does place requirements on the choice of SSL port.

H. Database Initialization.

1. Creating Tables

To create the database tables for the PPT Server, the script create.sql in the database/tables directory may be activated. This script creates tables and sequences to store the deal log. The tables and sequences must not already exist in the database. In a preferred embodiment, the tables created are:

deal

leg

requirement

component

line

settlement_detail

The tables sequences are:

cetsid_no_seq

deal_no_seq

leg_no_seq

requirement_no_seq

component_no_seq

line_no_seq

settlement_detail_no_seq

2. Creating Stored Procedures and Functions

To create the stored procedures and functions for the PPT server, the script create.sql may be activated in the database/proc directory

insert_deal

insert_requirement

insert_leg

insert_settlement_detail

insert_component

insert_line

update_deal

I. Graphical User Interface Screen Layouts

A detailed description of an exemplary graphical user interface that could be used to implement the present invention is now provided. FIG. 13 shows an example of a graphical user interface screen 1300 that could be used in a preferred embodiment of the present invention. This user interface screen 1300 is displayed by PPT Applet 102 running on a Provider's workstation, as was described above, with reference to FIG. 1.

The top portion of the screen (shown as section 1310 in FIG. 13) is the Active Deals Blotter. The Active Deals Blotter allows dealers to monitor and pick-up requests for quotes (RFQs). The Dropdown Menu 1312, near the top right of the screen, allows the dealer to filter deals displayed in the blotter according to user preference. The available choices in a preferred embodiment are discussed below with reference to Table 5. The bottom portion of the screen (section 1320) comprises a set of deal tickets (depicted in FIG. 13 under tabs 1336a, 1336b and 1336c) one for each deal the user has selected for dealing. Using the deal tickets, users can, among other things, review trade details, send and withdraw quotes, and chat with the Customer.

Also at the top right portion of user interface screen 1300 is the Deal Log Button 1314. Selecting this button brings up another user interface screen (discussed in detail below with reference to FIG. 14) containing completed deals, which, among other things, allows the user to export the deals to a file having comma-separated values (CSV) format.

1. Active Deals Blotter

The Active Deals Blotter 1310 will now be described in more detail. As stated above, dealers use the Active Deals Blotter 1310 to monitor and pick up RFQs. In a preferred embodiment, the Active Deals Blotter 1310 does not show deals from other providers and only one deal at a time can be selected. New deals are added to the top of the blotter, pushing down the existing deals. The Status 1316 column shows the state of each deal. Deals may have one of at least eight states. For example, a newly submitted deal appears in the Active Deals Blotter 1310 as “Submitted.” Once a user has “picked up” the deal, its state changes briefly to “Locking” and then to “Negotiating”. The state changes to “Completed Buy” or “Completed Sell” if the deal is executed with the bank. It changes to “Nothing Done” if the customer cancelled the RFQ or executed the trade with another bank. The Status 1316 column shows “Failed” if an error occurs before the deal is completed. Status 1316 shows “Rejected” if the requested price doesn't match the current quoted price, the deal cannot be found or if the user has withdrawn the quote.

Deals may remain on the blotter for a specified period of time, such as 60 minutes. Each state may be color-coded in the blotter. The colors may be definable as a global initialization property. For example, the colors may be assigned as shown below in Table 4 below.

TABLE 4
Color Codes for Transaction States

| State | Color |
|---|---|
| Submitted | Black on Yellow |
| Locking | Black on Blue |
| Negotiating | Black on White |
| Pending | Black on Blue |
| Completed (buy) | Black on Green |
| Completed (sell) | White on Red |
| Nothing Done | Gray on White |
| Aborted | Gray on White |
| Failed | Gray on White |

The user interface may be configured so that the list of deals visible to a dealer in Active Deals Blotter 1310 is governed, for example, by the following rules:

(1) There is no routing of particular deals to particular users. All deals are routed to all users for that particular provider institution, regardless of location.

(2) When a user first logs into the system, all deals that are currently in the Submitted state are downloaded to the dealer's screen. Deals that are in the Negotiating, Completed, Withdrawn, Failed, Rejected and Nothing Done states are not downloaded. In other words, the user sees all deals sent to his provider firm that currently having Submitted status.

(3) As long as the user is logged in, the system tracks newly submitted deals and tracks changes in status for deals already on the blotter.

(4) When the user logs out, the contents of the blotter may be archived and/or discarded. When the user next logs in, Active Deals Blotter 1310 is refreshed as described above by downloading the deals that have Submitted status.

Table 5 below shows examples of filtering options that may be accessed by selecting the Dropdown Menu 1312 at the top right of the screen shown in FIG. 13

TABLE 5
Filtering Options

| Selection | Result |
|---|---|
| Submitted | are in submitted state for this provider |
| My Active | are in submitted state or are being negotiated by this trader |
| Open | are in submitted state or are being negotiated by this |
| | provider |
| All | (all deals for this provider) |

In a preferred embodiment, deals filtered out are temporarily hidden from the display rather than removed from the applet's memory. For example, if the user switches from “All” to “Submitted,” all deals not in submitted state will be removed from Active Deals Blotter 1310. If the user then switches back to All, the deals previously removed will re-appear. Preferably, the deals are filtered in real time. For example, if a Submitted deal is picked up by a dealer, it will be removed from the Active Deals Blotter 1310 of all other dealers immediately.

Active Deals Blotter 1310 contains the following fields:

(1) Status 1321, which shows the deal status, as described above.

(2) Time 1322 shows the number of seconds since the deal arrived at the blotter. Stops counting when the deal is in a terminal state.

(3) Ccy Pair 1323 shows the deal's currency pair. This field is typically shown in a bold font with the base and terms currency separated by a period.

(4) Customer 1324 shows the customer's name. This field is typically shown in a bold font with the user name and market maker name separated by an “@” sign.

(5) Trader 1325: Once the deal has been picked up, this field shows the login of the user negotiating the deal and market maker name separated by an “@” sign.

(6) Comp 1326 shows whether the deal is completed.

(7) Type 1327 shows the type of deal: SPOT, FWD, SWAP, SSP or MSP.

(8) Dir 1328 shows whether the dealt currency is being bought or sold. For a swap, the direction of the far leg is the one that should be displayed. For a two-way quote, the field should show “TWO.” For SSPs and MSPs, the field may be blank.

(9) Amount 1330 shows the dealt amount. For spots and forwards this amount is the value on the leg. For a swap this field is the value in the far leg and for an SSP or MSP this amount is the net of all the legs.

(10) Units 1331 shows the dealt currency.

(11) Value Dates 1332 shows the single value date (SPOT and FWD), or dual value dates (SWAP), or blank for an SSP or MSP. If the dates are benchmark dates (as determined by the API feed), the benchmark label should be shown as well as the date. The format may be configured to show as “1M (Sep. 9, 2001)” for a benchmark date and “Sep. 10, 2001” for a broken date. For swaps, “vs” should be used to separate the dates.

(12) SSI 1333 displays blank if the standard settlement instructions apply for every allocation of this deal, and ‘N’ if not.

(13) ID 1334 shows an order identification number.

Dealers may pick up a Submitted deal by double-clicking any column in the row for that deal in the blotter or by entering a sequence of characters on a keyboard (as described below with reference to Table 7). Doing so changes the status of the deal from “Submitted” to “Negotiating,” and creates a deal ticket for the deal. Once a deal has been picked up, it typically can only be negotiated by the dealer who picked it up. Accordingly, the system may be configured to prevent attempts by other users to pick up the same deal.

2. Deal Tickets

The operation of Deal Tickets will now be described in more detail. Deal Tickets are opened by double-clicking on a Submitted deal in Active Deals Blotter 1310 or typing a predefined sequence of characters on the keyboard as described in Table b 7 below. This causes a new tab to be opened below the Active Deals Blotter 1310. Dealers can switch between multiple deal tickets by clicking on tabs 1336a, 1336b or 1336c at any time. The deal for the currently selected tab is also highlighted in the Active Deals Blotter 1310 being displayed above Deal Ticket 1320. If there are more deal tickets than can be displayed in one row, a second row of tabs is displayed.

The deal ticket tabs 1336a, 1336b and 1336c display the following information: customer, currency pair, and time since the RFQ was received. The tabs may be color-coded based on the status of the particular deal. The colors used for color-coding the tabs may also be definable as a global initialization parameter. Table 6 below shows an example of one color-coding scheme that can be used in an embodiment of the present invention:

TABLE 6
Color Codes for Deal Ticket Tabs

| State | Color |
|---|---|
| Ticket needs attention: price is withdrawn or | Blinking |
| chat message is waiting | |
| Deal is quoted | Black on Background |
| | Color |
| Completed (buy) | Black on Green |
| Completed (sell) | White on Red |
| Nothing Done | Gray on Background Color |
| Pending | Black on Background |
| | Color |
| Withdrawn | Gray on Background Color |

A deal ticket typically contains four sections, as shown in FIG. 13. The deal entry area (section 1340 in FIG. 13) shows summary details of the deal and contains an input area for editing the spot rates. The spread value can be changed by clicking the up/down arrows or by using the keyboard shortcuts described below. The legs blotter (section 1350) shows details of each leg and allows the user to enter dealing rates for every leg. The allocations blotter (section 1360) shows the allocations in the currently selected leg. The chat area (1380) allows the user to chat with the customer.

3. Deal Entry Area

The Deal Entry Area 1340 of Deal Ticket 1320 contains the following fields:

(1) Spot Rate Editor 1341 shows the bid and ask spot rates and the spread. If the user clicks in one of the rates and enters a price, the spread will be calculated based on the difference between the two rates. If the user uses the up and down arrows to adjust a rate, both the bid and ask rates will move up or down and the spread will remain constant. If the spread is adjusted, the bid and ask rates are adjusted around the current mid rate. The bid and ask rates can be moved up or down in increments of a single point (“pip”) using the arrow buttons between the bid and ask rates. Similarly, the spread can be moved up or down in increments of two pips using the left and right arrow buttons next to the spread. Changing the spread will increase or decrease both the bid and offer price by one pip each. The arrows will affect the rate by ‘pips’ that follow standard conventions. In preferred embodiments, the spot rates are colored to indicate which spot rate is applied to which side of the RFQ. This is covered in detail below in the section entitled “Selecting Rates”.

(2) A Spot Applied Toggle (not shown in FIG. 13) is used to determine which spot rate is applied to which side of the deal. This toggle is not displayed for spot or forward deals. The function of this control is also covered in detail below in the section “Selecting Rates”.

(3) Timeout Editor Field 1343 allows the trader to set a timeout in seconds to automatically withdraw the quote. In a preferred embodiment, the default value is 15 seconds. Once the quote is sent, a count down field displays the time left until the quote is automatically withdrawn.

(4) Deal Summary 1344 shows the currency pair in terms of the base currency per terms currency).

(5) Buy/Sell Summary (also not shown) shows for a one-way quote, the total over all allocations where the dealt currency is bought, the total over all allocations where the base currency is sold, and the net total over all allocations. The amounts are in units of the dealt currency and are signed. The dealt currency is shown next to the amounts. For a two-way quote this section may be blank.

(6) Clicking SSI Hyperlink Button 1345 brings up a window with settlement instructions.

(7) Close Button 1346 withdraws the user from the RFQ and deletes the tabbed sheet for the Deal Ticket. This button is enabled, if the user does not currently have a price quoted. If the deal is in the “Negotiating” state when the close button is hit, the state is changed to “Aborted” and an abort message is sent and the tab for the Deal Ticket is closed. If the deal is in a “Terminal” state, the Deal Ticket is simply closed.

4. Legs Blotter

The Legs Blotter (shown in FIG. 13 as section 1350) shows the amounts and prices for each leg of a swap deal. Each row of the blotter shows a separate leg (with separate value dates). When a user selects a row in the legs blotter area (section 1350), the allocations that make up the selected leg appear in the allocations blotter (section 1360 in FIG. 13), which is located to the right of the legs blotter. The Legs Blotter 1350 preferably contains the following fields:

(1) Req 1352 shows the number of allocations in this leg.

(2) Value Date 1354 shows the value date of the leg. Preferred formats may include, for example, “9M (May 9, 2001)” for “benchmark” dates and “May 9, 2001” for “broken” dates.

(3) Cust Side 1356 shows whether the customer is buying or selling the dealt currency in this leg.

(4) Amount 1358 shows the net amount for this leg.

(5) Units 1359 shows the dealt currency.

(6) Bid Pts (not shown in FIG. 13) is an editable cell showing the bid points. If this cell is edited, All-In Bid 1364 is updated to reflect the new points. If the customer requests a one-way quote and the bid rate is not needed, this cell is left blank. This cell may also be blank if the transaction is a spot transaction. Bid Pts do not apply for spot deals. Otherwise, the cell will be colored according to the rules presented below in the section entitled “Selecting Rates”.

(7) All-In Bid 1364 is a cell showing the all-in bid rate. If the customer is asking for a one-way quote and the bid rate is not needed, this cell may be left blank. Otherwise, the cell may be colored according to the rules presented below in the section entitled “Selecting Rates”.

(8) Offer Pts (not shown) is an editable cell showing the offer points. If this cell is edited, All-In Offer 1368 may be updated to reflect the new points. If the Customer requests a one-way quote and the bid rate is not needed, this cell may also be left blank. This cell may also be left blank if the transaction is a spot transaction, and Offer Pts do not apply for spot deals. Otherwise, the cell may be colored according to the rules presented below in the section entitled “Selecting Rates”.

(9) All-In Offer 1368 is an editable cell showing the all-in offer rate. If the customer requests a one-way quote, and the bid rate is not needed, this cell may be left blank. Otherwise, the cell may be colored according to the rules presented below in the section entitled “Selecting Rates”.

The dealer can select a single row in this blotter by clicking on any of the cells in it. The highlighted row may be indicated with different background and foreground colors in the Req, Value Date, Cust Side, Amount and Units columns.

There are three buttons on the deal ticket for quoting.

(1) Send Button 1370 sends the current price on the ticket to the customer.

(2) Withdraw Button 1382 sends a withdraw command to withdraw the current quote to the customer.

(3) Withdraw All Button 1384 sends a withdraw command for all of the provider's current quotes.

As described above, Timeout Field 1343 determines the length of time a quote will remain valid. For example, if the value is set to 15 seconds, then 15 seconds after the dealer hits Send Button 1370, the system sends a withdraw message as if the user had hit Withdraw Button 1384.

5. Allocations Blotter

The Allocations Blotter 1360 shows the allocations for a selected leg. Each row shows a separate allocation and the following fields are shown:

Acct 1362 shows the allocation's account.

Side 1364 shows the customer's side for this allocation.

Amount 1366 shows the dealt amount for this allocation.

SSI 1345 shows whether the standard settlement instructions apply for this allocation? Blank for yes, ‘N’ for no.

6. Chat Area

Chat Area 1380 contains an upper box 1392 that displays messages sent and received, and a lower Text Field 1393, preceded by the “Chat:” label, for typing messages to be sent to the customer. Messages are sent to the customer by typing into the lower box and hitting the return key. They are then displayed at the bottom of the upper box along with the username and time, scrolling the contents if necessary. Messages sent by the customer are similarly displayed at the bottom of the upper box, scrolling the contents if necessary. The arrival of a new message from the customer turns the ticket's tab into the “needs attention” state by turning the row yellow. This can be cleared either by clicking on the tab or by sending a message in response.

7. Keyboard Controls

Table 7 shows of actions that may be assigned to certain keyboard strokes in an embodiment of the present invention.

TABLE 7
Keyboard Controls

| Key Stroke | Action |
|---|---|
| Control-up | Increase bid and offer one pip |
| Control-down | Decrease bid and offer one pip |
| Control-left | Decrease offer one pip and increase bid on pip |
| Control-right | Increase offer one pip and decrease bid on pip |
| Alt-up | Increase bid and offer five pips |
| Alt-down | Decrease bid and offer five pips |
| Alt-left | Increase offer five pips and decrease bid five pips |
| Alt-right | Increase offer five pips and decrease bid five pips |
| Control-s | Send quote |
| Control-w | Withdraw quote |
| Control-a | Withdraw all quotes |
| Control-c | Close deal ticket |
| Tab | Focus on next component |
| Shift-Tab | Focus on previous component |
| / | If focused in bid field, set focus to offer field |

8. Deal Log Blotter

The Deal Log Blotter 1400 shown in FIG. 14 is used to view and export executed trades. This Blotter appears when a dealer selects the Deal Log Button (1314 in FIG. 13) at the top right of the Active Deals Blotter 1310.

Users can narrow the search criteria by optionally specifying the Trade Date Range 1405, the Currency Pair 1407, the Trader 1409, or the Deal ID 1411. Trade Date Range 1405 shows the first and last trade dates. Dates may be entered in the dd-mmm-yyyy format, (e.g. Aug. 8, 2001). If the only “From” date is entered, the search is from the date forward. If only “To” date is entered, the search is from the date backwards. If both dates are entered, the search is between the two dates, inclusive.

The Currency Pair Field 1407 shows the currency pair of the deal. In a preferred embodiment, currencies can be entered as:

“USD.” Searches for trades with a base currency of U.S. dollars.

“.USD” Searches for trades with terms currency in U.S. dollars.

“USD” Searches for trades with either base or terms currency U.S. dollars. Entering “USD.JPY” causes the system for trades with base currency U.S. dollars and terms currency in Japanese yen.

Trader Field 1409 specifies the user's login. The search matches patterns beginning with the text entered. Customer Name Field 1410 allows the dealer to search by customer name or customer ID. The search matches patterns beginning with the text entered. Deal ID Field 1411 specifies the ID of a specific deal. The search matches only an exact value.

The Deal Log Blotter shown in FIG. 14 operates in a manner very similar to the Active Deals Blotter shown in FIG. 13, except:

(1) It shows only completed deals; (therefore, no status field is necessary);

(2) No time field is shown; and

(3) The trade date is shown.

Since the deal displayed in the Deal Log Blotter 1400 has already been executed, the direction is either buy or sell, even if the customer originally asked for a two-way quote.

Selecting a deal in Deal Blotter 1400 causes the deal's details to be shown in the Deal Ticket Area 1420. This is very similar to the Deal Ticket Area 1320 of FIG. 13, which is used when negotiating deals, except:

(1) Only one ticket is shown at a time (therefore there are no tabs); and

(2) All rates are read only.

Because the deal has been executed, the direction is either buy or sell, even if the customer originally asked for a two-way quote. Therefore, only one of the spot rates will be displayed. Similarly, for each leg, either the bid or ask rate will be displayed, but not both. In addition:

(3) There is no competition flag;

(4) There are no controls for sending and withdrawing quotes; and

(5) No fields can be modified.

The fields shown in Deal Log Blotter 1400 differ depending on the leg:

Spot legs display:

Req

Value Date

Cust Side

Amount

Units

All-In Bid

All-In Offer

Non-spot legs display:

Req

Value Date

Cust Side

Amount

Units

Bid PtsOffer Pts

All-In Bid

All-In Offer

Selecting the Export Button 1430 exports the deals shown in the blotter to a CSV formatted file, which may be displayed in a separate browser window or a spreadsheet-editing program, such as Microsoft Excel. Each row in the blotter contains an allocation. The columns may be exported in the following order, and the field names given below may be exported in a header row.

CCY Pair

Trade Date

Platform Deal ID

Value Date

VD Type (tenor of the value date)

B/S (buy or sell)

Dealt CCY

Dealt Amount

Contra CCY

Contra Amount

Spot Rate

Fwd PtsAll In

Spot Date

Cust Trade

Provider

Account

Bank Trader

In Comp

SSI

Cust Deal ID

Product

Leg ID

Rate Terms

Risk Amt Per Leg

SSI Text

Source ID

9. Settlement Instructions

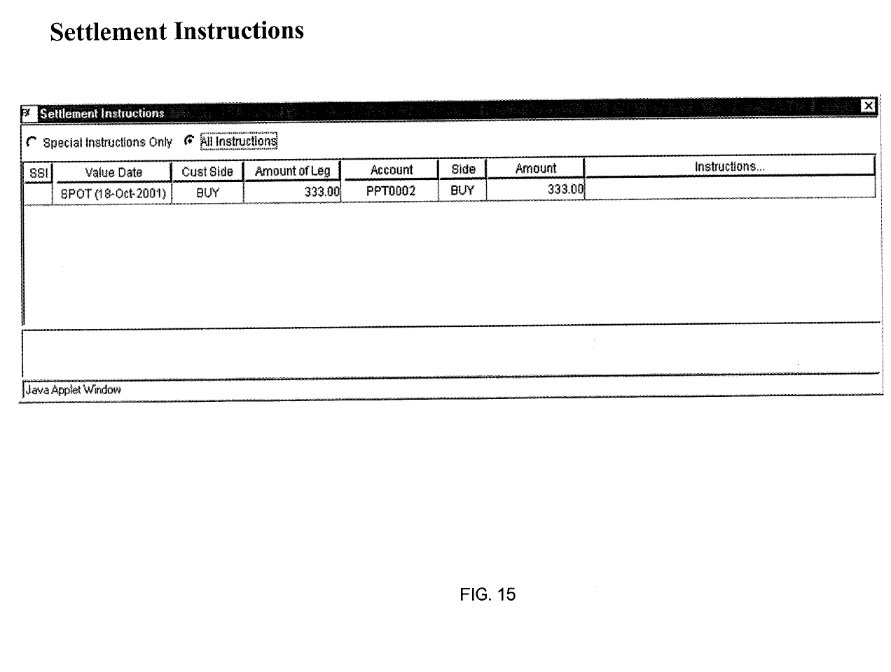

Selecting the hypertext link in the SSI Field 1432 displays a Settlement Instructions Window, which contains a blotter showing every allocation in the deal. An example of this window is shown in FIG. 15. The Settlement Instructions window may be configured to display:

Currency Pair

Value Date (with tenor if a benchmark)

Account

Customer Side

Dealt Amount

Dealt Currency

SSI—blank or N

Instructions

The user has the option either to display all allocations or just those with non-standard settlement instructions using a radio toggle. In a preferred embodiment, this window is read-only.

10. Graphical User Interface Screens for Amendments

As stated above, in a preferred embodiment, in addition to handling solicitations such as RFQs, PPT Applet 102 is configured to handle requests for amendments to previously submitted transactions, including Post Trade Allocations (PTAs), Value Date to Follow (VDTF), Rebook at Average Rate (RAR), Cancel and Rebook (CAR) and Historical-Rate Rollovers (HRR).

a) Post Trade Allocations (PTAs)

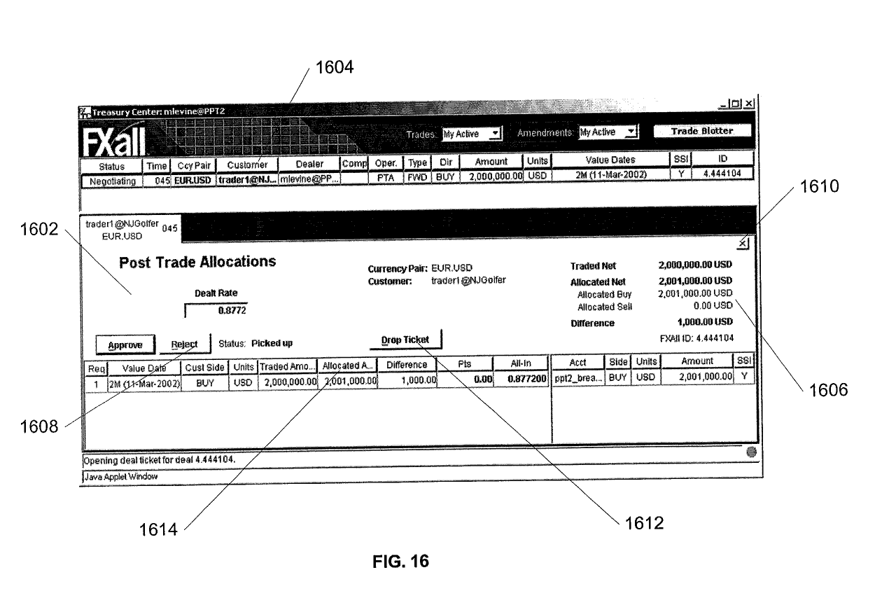

When a user picks up a deal marked for post trade allocations, he or she typically does nothing more than approve or deny the submitted allocations. FIG. 16 depicts an exemplary graphical user interface screen for an amendment ticket 1602 for a Post Trade Allocation (PTA), as it might be displayed in a PPT Applet configured to operate in accordance with the present invention. Amendment Ticket 1602 is similar to Deal Ticket 1320 described above with reference to FIG. 13. Customer Field 1604 of the header contains information about the customer user who submitted the order to the provider. The ticket also displays an aggregation of deal information 1606 on ‘Allocated Buy’ and ‘Sell’ totals (based on leg totals), the ‘Allocated Net’, and the ‘Difference between that and the ‘Traded Net’.

The ‘Approve’ and ‘Reject’ Buttons 1608 replace the Deal Entry Area 1340 of Deal Ticket 1320. The user clicks ‘Approve’ to approve the customer's amended allocations. The ‘Reject’ button aborts negotiation but leaves the terminal ticket open. The ‘x’ close button 1610 aborts the negotiation (if it is still active) and closes the ticket, while the ‘Drop Ticket’ button 1612 unlocks the order and allows another provider user to pick it up. The Legs Table 1614 contains additional columns describing the difference between the traded and allocated amount of each leg.

b) Value Date to Follow(VDTF)

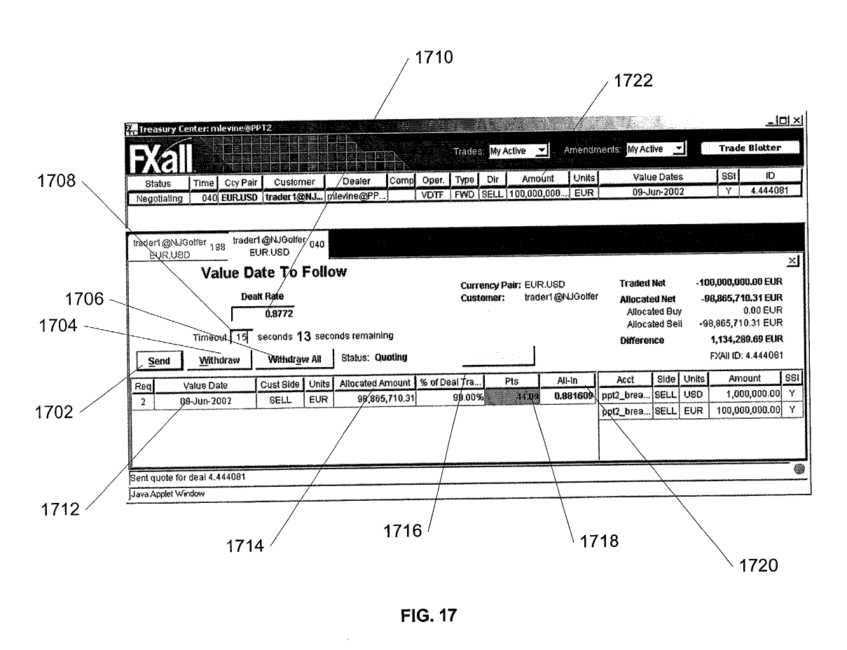

The Value Date to Follow Amendment Ticket, an example of which is shown in FIG. 17, is similar to Deal Ticket 1320 in that it also contains action buttons Send 1702, Withdraw 1704, and Withdraw All 1706, as well as editable Timeout Field 1708. However, the Dealt Rate Field 1710 is not editable. Points on non-spot legs are editable. Legs Table 1712 displays the ‘Allocated Amount’ 1714 and its corresponding ‘% of Deal Traded’ 1716.

When the Points Field 1718 of a leg is changed, the All-in Rate 1720 is updated, just as it is on a Deal Ticket 1320 for an RFQ. If any of the leg's allocations are in the contra currency, their new equivalence in the dealt currency (based on the new all-in) is calculated immediately and reflected in the leg's ‘Allocated Amount’ total 1714 and the aggregate Amount Field 1722 in the ticket header.

c) Rebook at Average Rate (RAR)

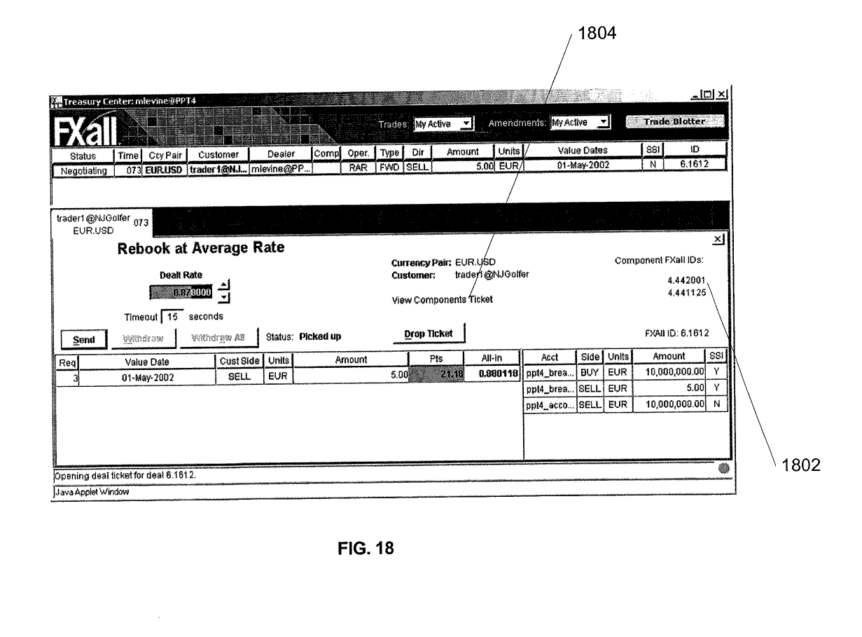

The RAR operation is an aggregation of multiple single-leg deals, which share a currency pair and value date. FIG. 18 depicts an exemplary user interface screen for an RAR operation. The provider user quotes a rate on the new deal, which is initialized to the weighted average rate of the original legs. The ticket allows editing both spot rate and forward points (provided the leg is not a spot date). The spot rate is displayed to an extra two digits of precision than is standard for the currency pair.

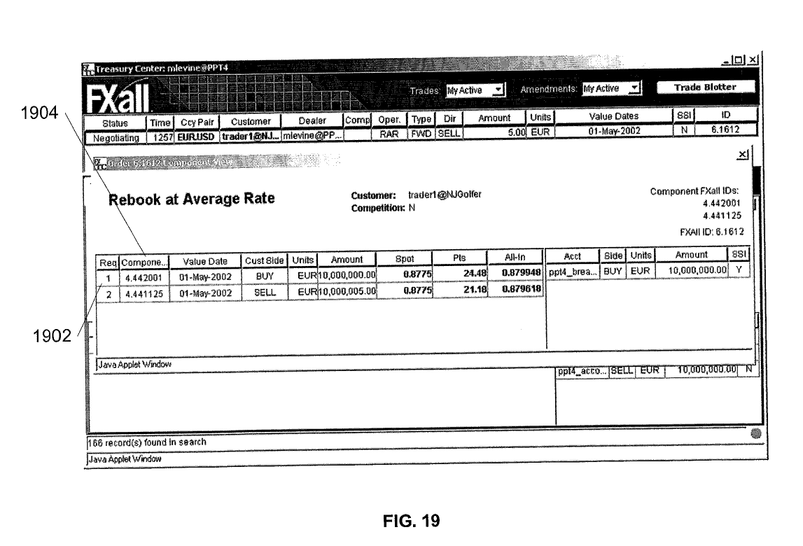

The header displays the Component IDs 1802 of the component deals. The ‘View Components Ticket’ Link 1804 opens a read-only dialog (shown in FIG. 19) displaying the original deals in more detail. The Legs Table 1902 of the read-only ticket contains a column labeled ‘Component ID’ 1904, which indicates from which deal that leg is derived.

d) Cancel and Rebook

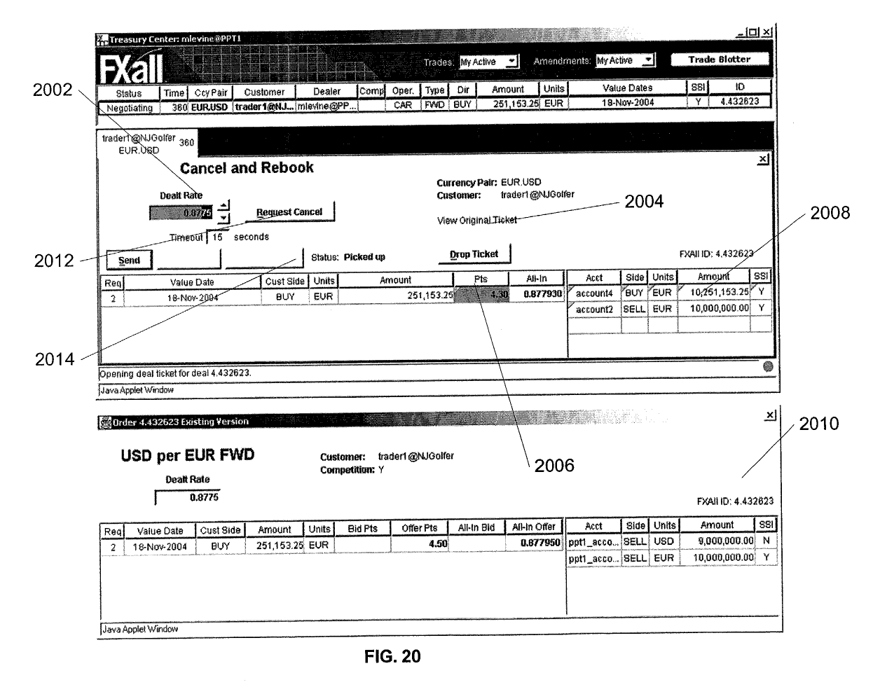

The Cancel and Rebook operation allows a deal to be cancelled and optionally rebooked as a new deal. An example of an amendment ticket for a Cancel and Rebook operation is shown in FIG. 20. If the customer proposes spot and points rates, these are initially shown on the amendment ticket in Dealt Rate Field 2002. Otherwise the Dealt Rate is initialized with the original deal's rates. The ‘View Original Ticket’ Link 2004 launches a read-only dialog 2010, which displays the original deal.

In a preferred embodiment, the spot rate field 2002 and Points field 2006 display yellow hash marks when their their current value is different from that of the original deal, including if the value was changed by the customer. Allocations Table 2008 also displays hash marks in every column to indicate changes and additions from the original deal, and a gray italicized font to indicate deletions. The user can edit the spot rate and points on non-spot legs.

In a cancel and rebook operation, quotes are sent to the customer for the proposed transaction and a negotiation proceeds like a regular trade or VDTF operation. If the user selects the ‘Request Cancel’ Button 2012 instead of sending a quote; the cancellation request is transmitted just like a rate quote, and can be withdrawn by the user or accepted/rejected by the customer. There is no timeout on a cancel request. The ‘Withdraw All’ Button 2014 on this and other tickets withdraws cancel requests, as well as quotes. If the customer accepts the cancel request, the deal is cancelled and not replaced.

e) Historical-Rate Rollovers

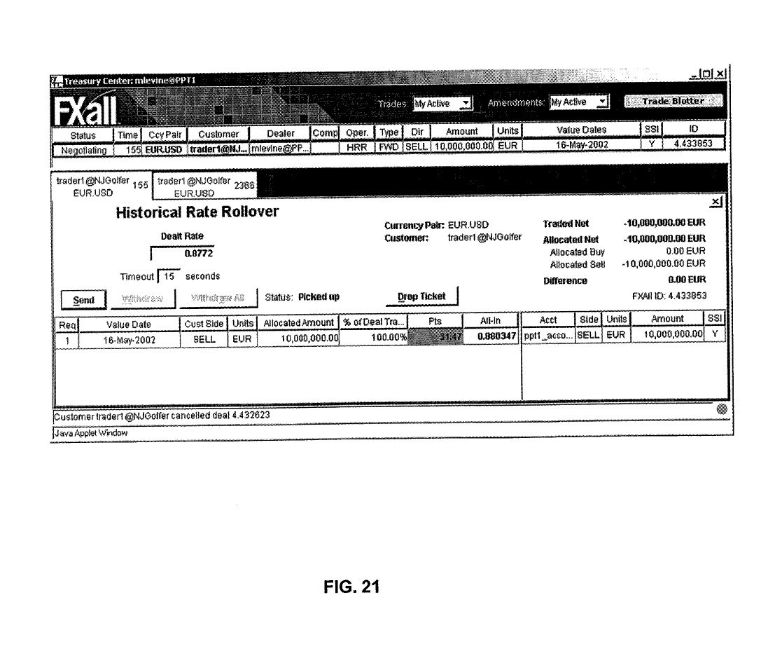

The Historical-rate Rollover amendment ticket, an example of which is shown in FIG. 21, looks almost identical to and operates just like the VDTF amendment ticket shown in FIG. 17, except for the amendment operation name.

J, Selecting Rates

The quoting process is complicated by the fact that any deal containing more than one leg usually contains a mixture of buys and sells. For example, if a Customer buys the base currency in a 3M swap, then the Customer is (by definition) buying the base currency on the 3M leg and selling the base currency on the spot leg. In general, therefore, there is a non-trivial and reliable relationship between the bid and ask sides of the deal and the bid and ask sides of each rate used to make up the quote. This relationship may be put to practical use in a system configured in accordance with the present invention.

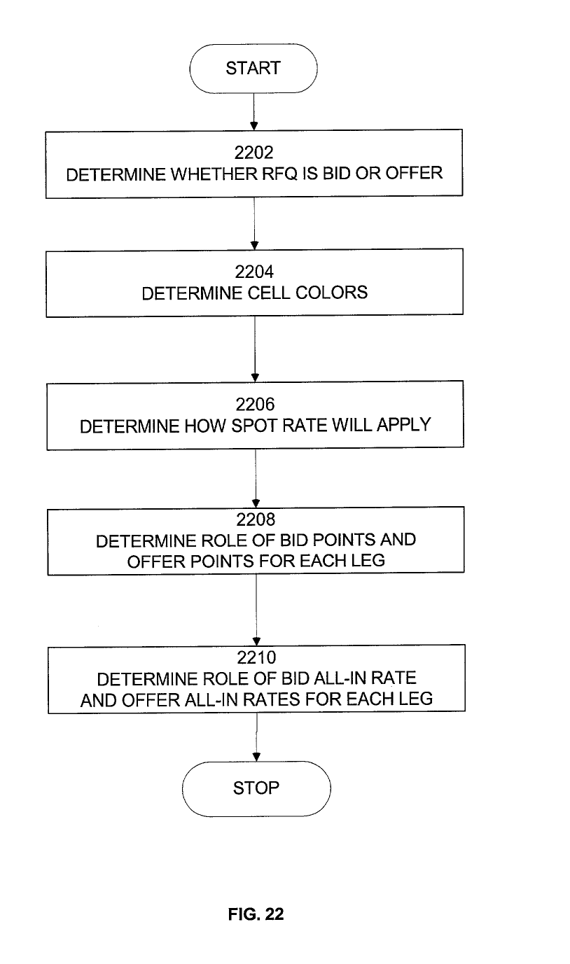

The flow diagram of FIG. 22 shows the steps performed by the invention to determine which rates are used and how the relationship will be displayed to the dealer. The first step, step 2202 in FIG. 22, is to determine if the RFQ is a bid or an offer. For a spot or forward, the identification is trivial (bid for sell, offer for buy). For a swap, the far leg determines whether the RFQ is a bid or an offer. An SSP is always an offer because the Customer is always buying. Next, in step 2204, the system determines the color use in displaying cells according to a specified color-coding scheme. In a preferred embodiment, rates to be used on the bid side of the deals are shown in red, while rates to be used in the offer side of the deal are shown in green. For a two-way quote, both colors are present.

The next step, step 2206, is to determine how the spot rate will be applied. The spot rate is said to be applied “crossed” if the bid spot rate is used on the offer side of the deal (and vice-versa), and “uncrossed” if the bid spot rate is used on the bid side of the deal (and vice-versa). The system determines whether the spot rate is applied crossed or uncrossed as follows: For a spot or forward deal, the spot rate is applied uncrossed. For a swap deal, the spot rate is applied uncrossed if the magnitude of the far leg is greater than the magnitude of the near leg. Otherwise (including if the magnitudes are equal) the spot rate is applied crossed. For an SSP or MSP, the spot rate is applied uncrossed if the net position is long. Otherwise (including if the net position is flat), the spot rate is applied crossed.

The “Spot Applied” Radio Button (not shown in FIG. 13) is set to show the colors according to the customer's side of the deal. The view to show the providers side of the deal, the user must flip the bid and offer by toggling the radio button. The spot rate used on the bid side of the deal (if any) is colored red and the spot rate used on the offer side of the deal (if any) is colored green. Any spot rate not used in making a final price is colored black on a white background to indicate that it is purely for reference.

In step 2208, a determination of the role of bid points and offer points is made for each leg of the transaction. The market bid points apply when the leg is being sold, the market offer points apply when the leg is being bought. The dealer enters market bid rates into the cells marked “bid” and market offer rates into the cells marked “offer”. The points are color-coded according to whether the rate is used on the bid side of the deal or the ask side of the deal. Any points not used in making a final price are left blank and cannot be edited. For a leg with a value date of spot, the points are not needed and are therefore always blank.

In step 2210, the role of bid all-in and offer all-in is determined for each leg of the deal. The bid all-in applies when the leg is being sold, the offer all-in applies when the leg is being bought. The all-ins are color-coded according to whether the rate is used on the bid side of the deal or the ask side of the deal. Any all-ins not involved in a final price are left blank.

Some examples of how a system configured to display rates according to this embodiment of the present invention are now provided.

### EXAMPLE 1

User buys 100m USD vs JPY at spot. In this case, the colored fields (Offer Spot and All-in Offer) are displayed in green.

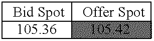

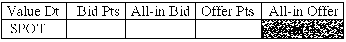

### EXAMPLE 2

User buys 100m JPY vs USD at spot. The colored fields (Bid Spot and All-in Bid) are displayed in red.

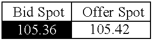

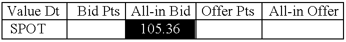

### EXAMPLE 3

User buys 100m JPY vs USD at 2M vs SPOT. The colored fields (Offer Spot, Bid Pts, All-in Bid and All-in Offer) are shown in red.

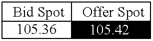

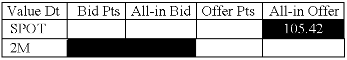

### EXAMPLE 4

User sells 100m JPY vs USD at 2M vs SPOT. The colored fields (Bid Spot, All-in Bid, Offer Pts and All-in Offer) are shown in green.

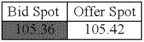

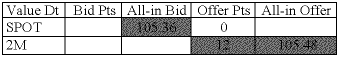

### EXAMPLE 5

In Example 4, if the dealer hits the Flip Spot Button, the Bid Spot, All-in Bid Offer Pts and All-in Offer fields turn green.

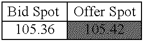

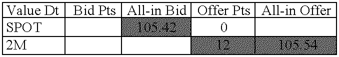

### EXAMPLE 6

Customer requests a two-way quote on 100m JPY vs USD at 2M vs SPOT. In this case, the Bid Spot, All-in Bid for the SPOT, Offer Pts at 2M, and All-in Offer at 2M are colored green, while the Offer Spot, Bid Pts at 2M, All-in Bid at 2M, and All-in Offer for the SPOT, are all colored red.

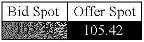

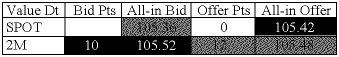

### EXAMPLE 7

If the dealer in Example 6 hits the Flip Spot Button, the Bid Spot, Bid Pts at 2M, All-in Bid at 2M and All-in Offer for the Spot will be colored red, while the Offer Spot, All-in Bid for the Spot, Offer Pts at 2M and All-in Offer at 2M will be colored green.

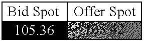

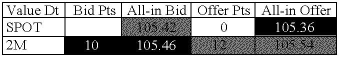

V. Initial Deal Rates

In a preferred embodiment, the RFQ message is sent from the PTT Server 122 along with indicative two-way values for each leg of the deal. A separate rate-generating program, a rate “feed” or a rate server coupled to PPT Server 122 or PPT Applet 102, may supply these rates. PPT Applet 102 uses these rates to pre-populate the deal ticket. If a required rate is not provided, it will be interpolated from other rates the PPT Applet has for a given currency pair.

Occasionally, however, a Customer requests a deal involving a cross currency pair in which the rate for one of the currencies is not available from the indicative price generator or rate feed. If the two USD components of the cross currency pair are present, however, the missing rate for the cross component is calculated as follows.

Step 1: Using a given currency pair (e.g., XXXUSD and YYYUSD) and the requested tenor of the transaction (e.g., 1W, 1M, 2M), the system generates a date object. This step is generally accomplished by referring to a standard date look up table, as known in the art. In a preferred embodiment, the date look up table takes weekends and holidays for the particular currencies into account.

Step 2: The bid rate (XXXYYYbid) and the ask rate (XXXYYYask) for the cross currency pair are then calculated as follows:

First, for the spot rates:

For XXXUSD and YYYUSD:

XXXYYYbid=XXXUSDbid/YYYUSDask; and

XXXYYYask=XXXUSDask/YYYUSDbid.

For XXXUSD and USDYYY:

XXXYYYbid=XXXUSDbid*USDYYYbid; and

XXXYYYask=XXXUSDask*USDYYYask.

For USDXXX and USDYYY:

XXXYYYbid=USDYYYbid/USDXXXask; and

XXXYYYask=USDYYYask/USDXXXbid.

For USDXXX and YYYUSD:

XXXYYYbid=1/(USDXXXask * YYYUSDask);

XXXYYYask=1/(USDXXXbid * YYYUSDbid)

As stated above, participants in certain financial markets rely on a set of “standard” value dates, called “tenors.” In the FX market, for instance, the standard tenors are 1W (1 week), 2W (2 weeks), 3W (3 weeks), 1M (1 month), 2M (2 months), 3M (3 months), 6M (6 months), 9M (9 months) and 1 Y (1 year). However, when a Customer requests that a transaction settle on a “non-standard” value date (also called an “odd” or “broken” date), the FX rate for that date may not be immediately available In embodiments of the present invention, the FX rate for the broken date rate is interpolated according to the following algorithm:

Step 1: Compare the targetDate to each date in the list. When a date is found that is greater then the targetDate, then that date will be used as the HighDate and the previous date will be used as the LowDate.

Step 2: Assign the values corresponding to HighDate and LowDate to the variables LowDateValue and HighDateValue.

Step 3: Calculate the TargetDateValue using the following algorithm:

TargetDateFwdPts=LowDateValue+(ValueDiff*DayDiff/NumberOfDays)

where . . .

ValueDiff=HighDateValue−LowDateValue

DayDiff=TargetDate−LowDate

NumberOfDays=HighDate−LowDate

Limits:

if TargetDate<Spot=> Forward Points not calculated;

if Spot<TargetDate<1W=> Assume spot is 0 fwd pts and calc as described above;

if TargetDate>1Y=> Forward Points not calculated.

In a preferred embodiment, cross currency forward points are then calculated as follows:

Step 1: Calculate bid/ask Spot as above.

Step 2: Calculate the bid/ask forward points as follows:

a) If there is a broken date, calculate the bid and ask points for the broken date as described above.

b) Calculate the bid outright and ask outright for each underlying USD spot and points:

bid outright=ask spot+bid pts,

ask outright=bid spot+ask pts.

c) Calculate the cross for each outright as described above.

d) Back out the points from the calculated crosses as follows:

bid points=bid outright−ask spot,

ask points=ask outright−bid spot.

VI. Executions

When a customer accepts a quote, PPT Applet 102 receives an execution notification (sometimes referred to as an “offer to deal”). The determination of whether to accept the execution is made in the individual applet to ensure comparison with the most recent action on the part of the trader. This provides the trader with an advantage in the negotiations because he or she will always have the last word.

If PPT Applet 102 receives the execution notice and the exact quote on the execution is still open from the trader's perspective, the execution is completed. In a preferred embodiment, this happens automatically. However, if the trader has withdrawn or changed the quote, the execution is denied.

VII. Negotiating Multiple RFQs

As stated above, each RFQ selected by a trader will cause a Deal Ticket (shown in FIG. 13) to be created. The trader can navigate between deal tickets by clicking on a tab or by using the PgUp and PgDn keys to scroll through them.

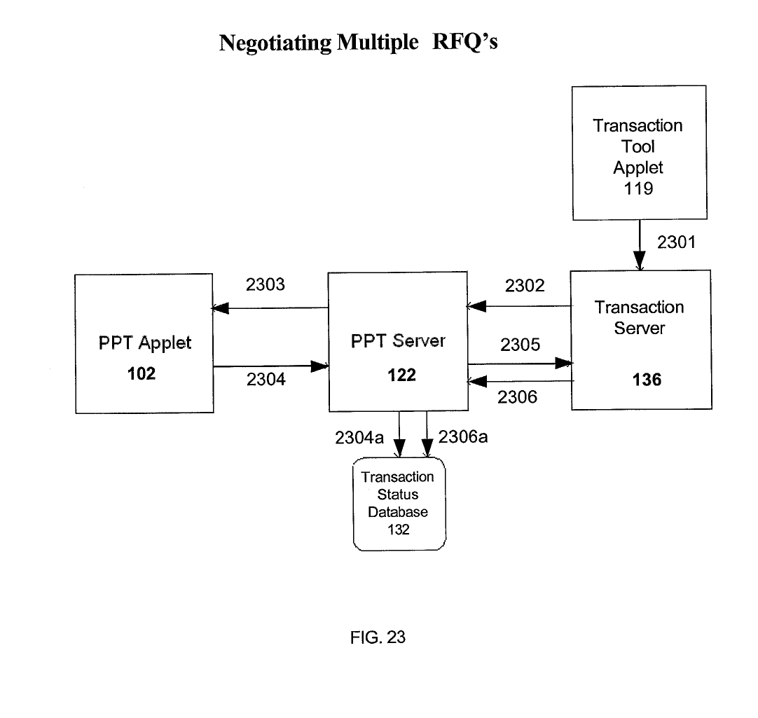

FIG. 23 illustrates the message flow sequence in a typical foreign exchange transaction. First, an RFQ comes into Transaction Server 136 from Transaction Tool Applet 119. This transmission is represented with flow 2301 in FIG. 23. Transaction Server 136 sends a Deal Request to PPT Server 122 (flow 2302). Next, at flow 2303, the Deal Request is sent from PPT Server 122 to PPT Applet 102. In flow 2304, PPT Applet 102 sends an Accept/Reject signal provided by the Trader back to PPT Server 122. In a preferred embodiment, and as shown as flow 2304a in FIG. 23, a status record for the Deal Request in Transaction Status Database 132 is now updated to reflect the fact that the status of the Deal Request has changed to a “Negotiating” state. Alternatively, and according to some embodiments, it may be at this point, and not before, that the deal is first entered into Transaction Status Database 132.

Next, in flow 2305, PPT Server 102 sends the Deal Accept/Reject signal is back to Transaction Server 136, which notifies the Customer. Then Transaction Server 136 sends a Deal Complete/Incomplete signal to the PPT Server 122 via flow 2306. And finally, as represented by flow 2306a, Transaction Status Database 132is updated with the current deal status. The current status will be “Complete” if the Trader accepted the deal, or “Incomplete if the Trader rejected it.

VIII. Administration

In a preferred embodiment, PPT Server 122 is configured to launch a small administrative application, called a servlet, upon verification that a user has permission and authority to do so. The servlet may be configured to display an HTML form that allows an administrator to delete dealers at runtime. An administrator typically will open a new browser window to display this page. The administrative servlet's URL is http://{hostname}/ppt/adminServlet.

The invention, which uses a User Validation API to authenticate users, can support at least two types of users, Traders—who can negotiate RFQs and examine the deal log—Middle Office Users—who can examine the deal log only. Users can change their passwords prior to logging in. In a preferred embodiment, users must enter their current password and then enter their new proposed password twice. If the user's old password is correct and the new password is entered identically twice, the request to change the password is executed. In a preferred embodiment, Authenticator 134 manages user sessions and therefore knows whether a user is already logged in, in which case PPT Server 122 sends the user an error message. Accordingly, users are not allowed to login twice.

IX. System Configuration

PPT Applet 102 may be configured to allow PPT Server 122 to choose the set of tradable currencies so that it matches the set of currencies available in the Integration Tier 130. For each tradable currency pair, the PPT Applet can be configured with a specified base currency, as well as a specified points divider (the number of decimal points).

X. Failure and Recovery

When an PPT Server operation fails, the client application displays a traffic light that will show whether there is/not connectivity. If possible, the server will detect a failure within a specified amount of time and send the transaction server a message indicating that the Provider is unavailable. Where possible, the server sends withdraw quote signals for any quotes currently being negotiated. The client application attempts to reconnect to the PPT Server after going a specified period of time (e.g., 10 seconds) with no response from the applet. The applet user normally does not need to login again. Once the system is restored, the application displays any new RFQ's. Old quotes will have either been withdrawn or timed out. If an execution came in while the system was down, the PPT Server will test the regular parameters, including the expiry of the quote, to verify that the execution was valid.

XI. Trader Use Examples

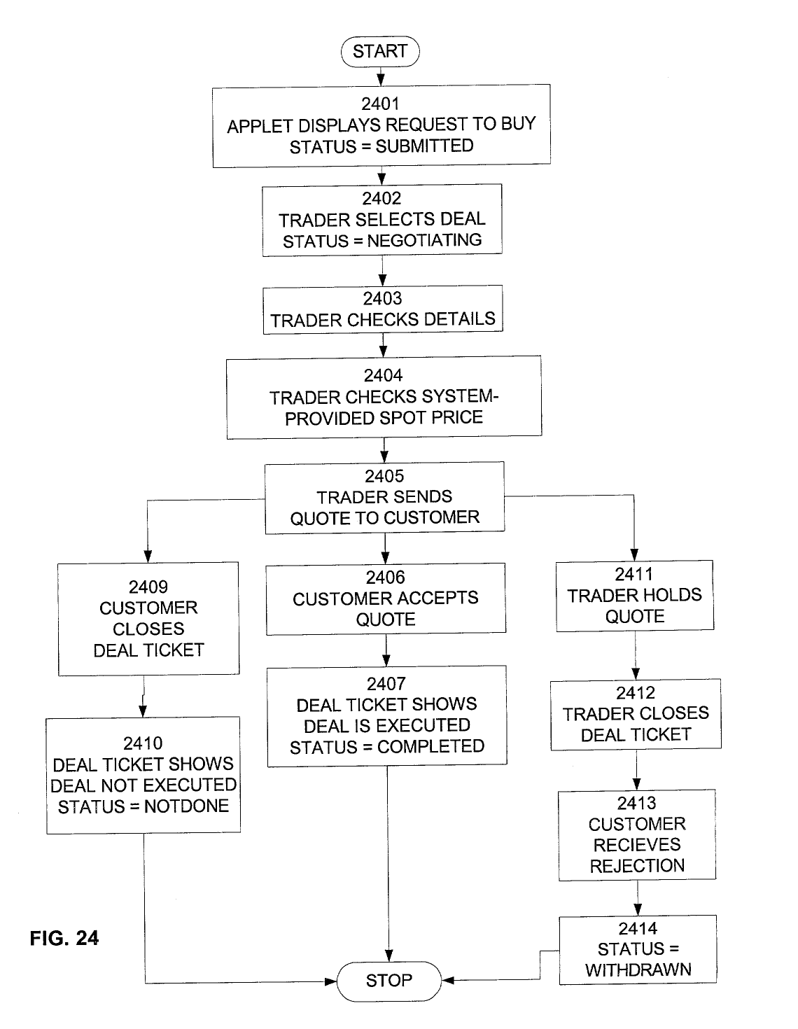

The flow diagrams shown in FIGS. 24, 25, 26 and 27, and described below, illustrate the steps that are performed in an embodiment of the invention when a trader engages in certain types of transactions.

### EXAMPLE 1

### Trader Negotiates an RFQ

Turning first to FIG. 24, assume that a trader is already logged into the system and has the Active Deals blotter selected. As shown in step 2401, a new row appears on the blotter indicating a request to buy $12M against Yen at spot. The status of the deal is “Submitted,” indicating that no other trader is yet negotiating the deal. In step 2402, the trader selects the deal to begin negotiations. The status of the deal changes to “Negotiating” and the PPT Applet displays a deal ticket. Next, in step 2403, the trader checks the deal details, especially the currency pair, amount, direction, customer name, and account allocations. The trader then checks the spot price provided by the system, step 2404, and adjusts the price as necessary.

In step 2405, the trader sends the quote to the customer. In a busy or volatile market, this step 2405 may comprise several sub-steps. For example, if the market rates change after the trader has sent a first quote to the customer, the trader may decide to “update” the quote with a new rate and send it again. Alternatively, the trader could decide to “hold” the quote (which withdraws it from the customer) a while before updating it and resending it to the customer. In the next step, step 2406, the customer accepts the quote. As shown in step 2407, the deal ticket shows that the deal has been executed and he status of the deal in the blotter changes to “Completed” for all users.

If the customer closes his deal ticket without accepting the trader's quote, shown as step 2409 in FIG. 24, the deal ticket will show that the deal has not been executed. Moreover, the status of the deal in the blotter changes to “NotDone,” step 2410. If, on the other hand, the trader “holds” the quote, thereby causing it to be withdrawn from the customer, as in step 2411, and subsequently closes his deal ticket, as in step 2412, then the customer will receive a rejection/denial signal, as in step 2413, letting him know that the dealer's quote is no longer available. In the final step, step 2414, the status of the deal in the blotter changes to “Withdrawn” and the deal is stopped.

### EXAMPLE 2

### Trader's Colleague Negotiates a One-Way Spot RFQ

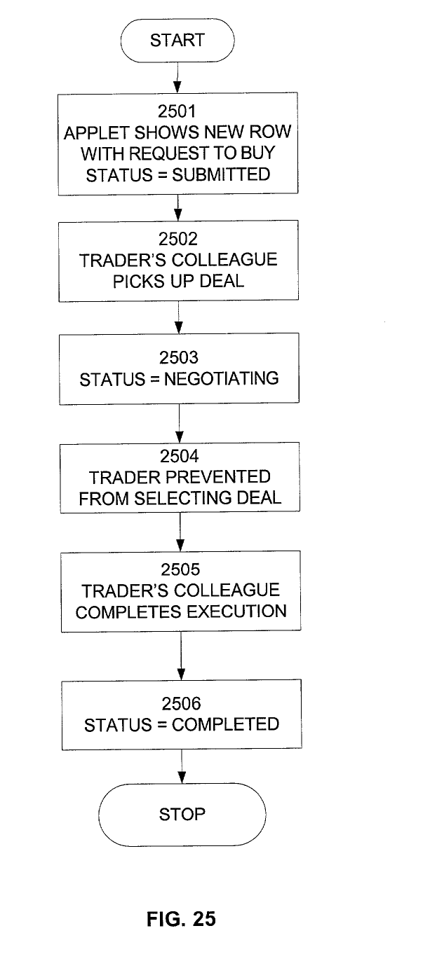

FIG. 25 illustrates what happens when a trader's colleague negotiates a one-way spot RFQ. Again, this example assumes trader is already logged into the system and has the Active Deals Blotter selected. First, in step 2501, a new row appears on the blotter indicating a request to buy $12M against Yen at spot. The status of the deal is “Submitted,” indicating that no other trader is currently negotiating the deal. Next, in step 2502, the trader's colleague picks up the deal. The status of the deal changes to “Negotiating,” step 2503. No deal ticket is opened for the trader. In fact, as shown in step 2504, the trader is actually prevented from selecting the deal. Eventually, the trader's colleague completes the execution, step 2505. Therefore, in step 2506, the status of the deal is changed to “Completed.”

### EXAMPLE 3

### Middle Office End-of-day Procedure

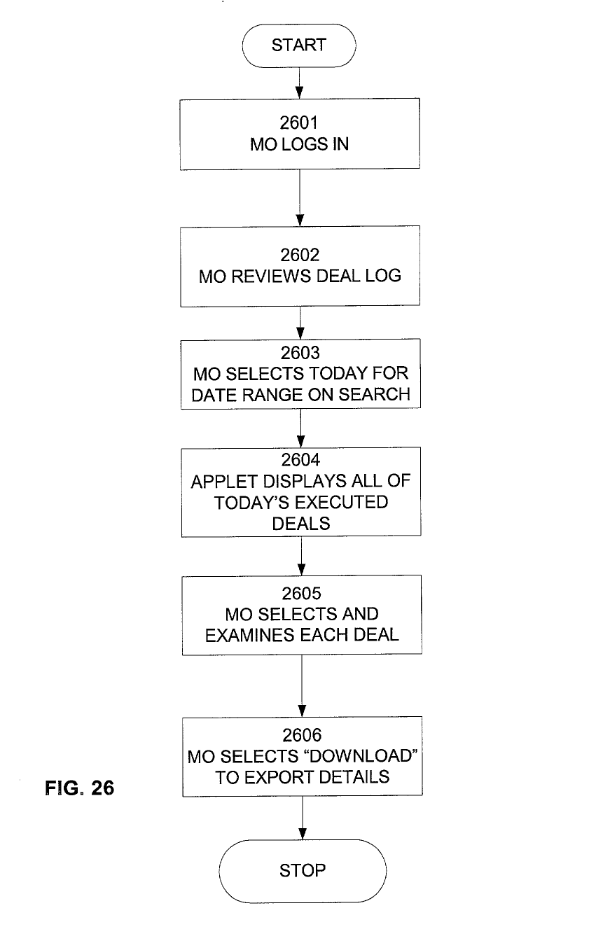

FIG. 26 illustrates a Middle Office End-of-Day procedure. First, in step 2601, the Middle office user (MO) logs in as a Middle Office user. In step 2602, the MO reviews the deal log. In some embodiments, this is the only functionality configured to be available to Middle Office users. Next, in step 2603, the MO selects today's date for the start and end of the date range for a search. The MO runs the search (step 2604) and sees all deals executed in the bank today. Each row of the blotter shows a separate deal. In step 2605, the MO examines each deal by selecting it in the blotter. The leg and allocation details are displayed in the ticket section below the blotter. And finally, in step 2606, the MO selects the “download” button to export the details of the selected deals in CSV format.

### EXAMPLE 4

### Trader Negotiates a Complex SSP

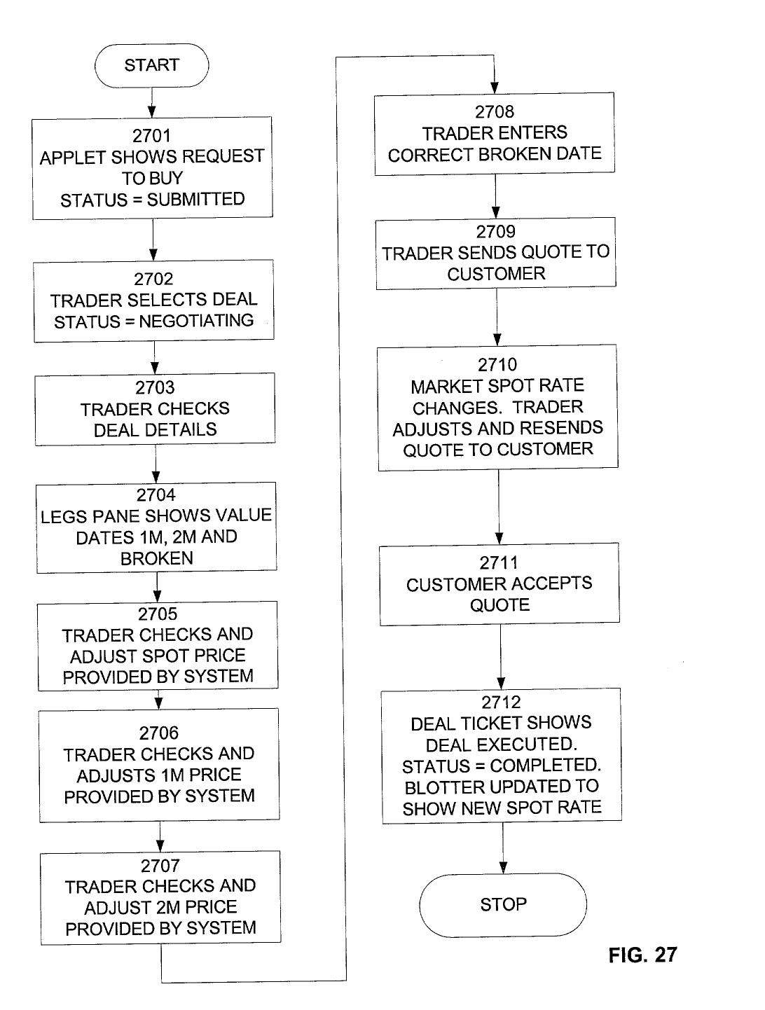

FIG. 27 illustrates what happens when a trader negotiates a complex SSP. To begin, the bank trader is logged into the system and has the Active Deals blotter selected. First, in step 2701, a new row appears on the blotter indicating a request to buy $10m against Yen in a block trade. The status of the deal is Submitted, indicating that nobody is yet negotiating the deal. Next, in step 2702, the trader selects the deal to begin negotiating it. The status of the deal changes to Negotiating and the system opens a deal ticket. In step 2703, the trader checks the deal details, especially the currency pair, net amount, direction, customer name. In step 2704, the legs pane shows that the deal has three value dates: 1M, 2M, and a broken date.

At the next step, step 2705, the trader checks the spot price provided by the system and adjusts the price as necessary. At step 2706, the trader selects the 1M leg, checks the 1M points provided by the system, and adjusts the price if necessary. Then, in a step 2707, the trader selects the 2M leg, checks the 2M points provided by the system, and adjusts the price if necessary.

Next, at step 2708, the trader selects the broken-dated leg. The points are defaulted to 0 because no rate was supplied in the RFQ message. The trader enters the correct broken-dated points. At step 2709, the trader sends the quote to the customer. At step 2710, the spot rate changes in the market. The trader updates the spot price and resends the quote to the customer. The customer accepts the quote, step 2711. And, finally, at step 2712, the deal ticket shows that the deal has been executed. The status of the deal in the blotter changes to “Completed.” The blotter is updated to show the new spot rate.

XII. Servers as Separate Java Virtual Machine Instances

In a preferred embodiment, PPT Server 122 and Amendment Tool Server 126 are configured to run in separate JVM instances. This configuration improves the scalability of overall system because different processes handle provider connections and customer connections. With this configuration, for example, only one instance of Amendment Tool Server 126 is required to provide support for multiple customers connections.

XIII. Real-time Working Blotter Updates

When Transaction Server 136 and Amendment Tool Server 126 add information to Transaction Status Database 132 concerning a new trade, Amendment Tool Server 126 is configured to automatically retrieve the new trade information, and determine the customer and the status of the trade. If the trade requires amendment, the Amendment Tool Server 126 is configured to notify the customer that an update is available. If the customer happens to be viewing the Working Blotter on the Amendment Tool Interface 118, this notification will cause the customer's Working Blotter to automatically refresh itself with the new trade information. Similarly if a customer is viewing the Working Blotter and a deal's status changes, the Working Blotter will be updated in real-time to reflect the new status.

XIV. “Break” Accounts

In a preferred embodiment, all proposed transactions that allocate to at least one designated “Break” account are eligible for PTA, VDTF, and RAR amendments. All trades are potentially eligible for Cancel & Rebook and Historical-Rate Rollovers.

“Break” accounts may be set up at runtime and Amendment Tool Server 126 may be configured to cache the list of “Break” accounts on startup. Thereafter, if Amendment Tool Server 126 receives an amendment request for a transaction involving an account not listed in its cached list of break accounts, it will check the database to determine whether the account is a valid. If the account is valid, it will be added to the cached list of break accounts and the amendment operation on the transaction will be permitted.

XV. Locking and Unlocking Deals

In a preferred embodiment, any operation that operates on accounts or deals is first required to acquire a lock on the account or deal before the operation can commence. This rule prevents corrupting data as a result of partial and overlapping operations. Moreover, only one Customer can work on a post-trade operation at a time. The lock on the deal expires when the Customer's session times out, the deal has reached a terminal state, or the Customer aborts the ticket. Additionally, when a Provider user is disconnected or logs out, the server sends an abort quote request to the customer user currently working on a deal with that Provider.

The present invention has been disclosed and described herein in what is considered to be its most preferred embodiments. It should be noted that variations and equivalents may occur to those skilled in the art upon reading the present disclosure and that such variations and equivalents are intended to come within the scope of the invention and the appended claims. Therefore, for example, it should be understood by one skilled in the art that the present invention is not limited to foreign exchange transactions, and may be beneficially applied to other types of transactions as described above.

What is claimed is:

1. A computer-implemented method for conducting a currency exchange transaction, comprising:
receiving from a customer, via a first data communications channel, a request for quotes (RFQ) for the currency exchange transaction;
receiving, via a second data communications channel, an indicative price for the currency exchange transaction, the indicative price being based on a currency pair for the RFQ;
presenting, on a multiplicity of user workstations, an alert indicating that the RFQ has arrived;
receiving from one user workstation in the multiplicity of user workstations an activation signal, generated in response to an input of a first user, the activation signal indicating that the first user has selected the RFQ for dealing;
responsive to the generation of the activation signal by the first user, preventing a second user from selecting the RFQ for dealing, sending a notification to the customer that the RFQ has been selected for dealing,
displaying the currency exchange transaction to the first user,
displaying the indicative price to the first user;
receiving from the first user a price quote for the currency exchange transaction, and
sending the price quote to the customer over the first data communications channel;
receiving from the customer an offer to deal responsive to the price quote;
determining whether offer to deal was received during a specified period of time;
determining whether the first user has sent a command to stop dealing on the currency exchange transaction;
transmitting the offer to deal to the first user;
receiving from the first user a deal completion signal responsive to the offer to deal;
sending the deal completion signal to the customer;
executing the currency exchange transaction; and
sending the customer a confirmation.

2. The method of claim 1, wherein the alert comprises an visual signal.

3. The method of claim 1, wherein the visual signal comprises a summary of the currency exchange transaction.

4. The method of claim 1, wherein the alert comprises an audible signal.

5. The method of claim 1, wherein the alert comprises a visual signal and an audible signal.

6. The method of claim 1, wherein the price quote is equal to the indicative price.

7. The method of claim 1, wherein the first user generates the activation signal by selecting a summary of the currency exchange transaction with a pointing device associated with the one user workstation in the multiplicity of user workstations.

8. The method of claim 1, wherein the first user generates the activation signal by typing a designated set of characters on a user workstation in the multiplicity of user workstations.

9. The method of claim 1, further comprising the step of creating or modifying a financial transaction database.

10. A computer-implemented method for conducting a financial transaction, comprising:
receiving, via a data communications channel, a solicitation for the financial transaction;
presenting, on a user workstation, an alert indicating that the solicitation has arrived;
receiving from the user workstation an activation signal, generated in response to an input of a user, indicating that the user has selected the solicitation for dealing; and
responsive to the generation of the activation signal,
displaying the financial transaction to the user,
receiving a transaction term from the user for the financial transaction, and
sending the transaction term over the data communications channel.

11. The method of claim 10, wherein the transaction term comprises a price quote.

12. The method of claim 10, wherein the alert comprises a visual signal.

13. The method of claim 12, wherein the visual signal comprises a summary of the solicitation.

14. The method of claim 12, wherein the visual signal comprises a flashing icon.

15. The method of claim 10, wherein the activation signal is generated by selecting a summary of the financial transaction with a pointing device associated with the user workstation.

16. The method of claim 10, wherein the activation signal is generated by typing a designated set of characters on the user workstation.

17. The method of claim 10, wherein the alert comprises an audible signal.

18. The method of claim 10, wherein the alert comprises a visual signal and an audible signal.

19. The method of claim 10, wherein the financial transaction comprises a currency exchange transaction.

20. The method of claim 10, wherein the financial transaction comprises a money market transaction.

21. The method of claim 10, wherein
the solicitation comprises a request for quotes (RFQ) for the financial transaction; and
the transaction term comprises a price quote.

22. The method of claim 10, wherein the solicitation comprises a request to amend the financial transaction.

23. The method of claim 10, wherein the solicitation comprises a request to cancel the financial transaction.

24. The method of claim 10, wherein the solicitation comprises a request to rebook the financial transaction.

25. The method of claim 10, wherein the solicitation comprises a request to change a value date for the financial transaction.

26. The method of claim 10, wherein the solicitation comprises a request to change an execution rate for the financial transaction.

27. The method of claim 10, wherein the solicitation comprises a request to use a specified account to execute the financial transaction.

28. The method of claim 10, wherein the solicitation comprises a request to rebook the financial transaction at an average rate.

29. The method of claim 10, wherein the solicitation comprises a request to apply the rate of a previous financial transaction to the financial transaction.

30. The method of claim 10, further comprising the step of sending, responsive to the generation of the activation signal, a notification that the solicitation has been selected for dealing.

31. The method of claim 10, further comprising the step of receiving an offer to deal responsive to the transaction term.

32. The method of claim 31, further comprising the step of determining whether the user has sent a command to withdraw the transaction term.

33. The method of claim 31, further comprising the step of determining whether the user has sent a command to stop dealing on the financial transaction.

34. The method of claim 31, further comprising the step of determining whether the user has sent a command to deny the financial transaction.

35. The method of claim 31, further comprising the step of withdrawing the transaction term if the offer to deal is not received during a specified period of time.

36. The method of claim 35, wherein the step of withdrawing the transaction term comprises sending a withdrawal message over the data communications channel.

37. The method of claim 31, further comprising the step of transmitting the offer to deal to the user.

38. The method of claim 37, further comprising:
receiving from the user a deal completion signal responsive to the offer to deal; and
sending the deal completion signal.

39. The method of claim 38, wherein the deal completion signal comprises an acceptance.

40. The method of claim 38, wherein the deal completion signal comprises a rejection.

41. The method of claim 10, further comprising:
receiving, via a second data communications channel, an indicative price for the financial transaction, the indicative price being based at least in part on a detail of the financial transaction; and
prior to receiving the transaction term from the user, displaying the indicative price to the user.

42. The method of claim 44, wherein the detail comprises a currency pair for the financial transaction.

43. The method of claim 42, wherein the data communications channel and the second data communications channel are the same.

44. The method of claim 41, wherein the transaction term received from the user includes the indicative price.

45. The method of claim 10, further comprising the step of executing the financial transaction.

46. The method of claim 45, further comprising the step of sending, via a second data communications channel, a confirmation that the transaction was executed.

47. The method of claim 46, wherein the data communications channel and the second data communications channel are the same.

48. The method of claim 10, further comprising:
presenting the alert on a multiplicity of user workstations; and
responsive to the generation of the activation signal, preventing another user from selecting the solicitation for dealing.

49. A system for conducting a financial transaction, comprising:
means for receiving, via a data communications channel, a solicitation for the financial transaction;
means for presenting, on a user workstation, an alert indicating that the solicitation has arrived, the user workstation being configured to generate an activation signal, responsive to the input of a user, indicating that the user has selected the solicitation for dealing;
means, responsive to the input of the user, for displaying the financial transaction to the user;
means, responsive to the input of the user, for accepting a transaction term from the user for the financial transaction; and
means, responsive to the receiving means, for sending the transaction term over the first data communications channel.

50. The system of claim 49, further comprising:
means responsive to the receiving means, for presenting the alert on a multiplicity of user workstations; and
means, responsive to the generation of the activation signal, for preventing another user from selecting the solicitation for dealing.

51. A user interface for conducting a proposed financial transaction, comprising:
a first display region configured to display
an alert in response to a receipt of a solicitation to execute a proposed financial transaction, and
a user-activatible control configured to generate a signal that a user has selected the solicitation for dealing; and
a second display region configured to show, in response to the generation of the signal, a deal ticket summarizing the proposed financial transaction;
wherein the deal ticket is configured to receive a transaction term from the user for the proposed financial transaction.

52. The user interface of claim 51, wherein the first display region is further configured to display a list of solicitations received by a multiplicity of users.

53. The user interface of claim 52, wherein the first display region is further configured to show a current status for each solicitation in the list of solicitations received by all users.

54. The user interface of claim 52, wherein the list of solicitations is filtered according to a set of user preferences.

55. The user interface of claim 51, wherein the deal ticket comprises at least one of the following details of the proposed financial transaction,
a customer name,
a currency pair, and
an elapsed time since the solicitation was received.

56. Computer-executable software code, stored on a computer-readable medium, for conducting a financial transaction, comprising:
code configured to receive, via a data communications channel, a solicitation for the financial transaction;
code responsive to the receipt of the solicitation, configured to present, on a user workstation,
an alert indicating that the solicitation has arrived, and
a user-activatible control configured to generate an activation signal, responsive to the input of a user, and
code responsive to the generation of the activation signal,
to display the financial transaction to the user,
to receive a transaction term from the user for the financial transaction, and
to send the transaction term over the data communications channel.

57. The computer-executable code of claim 56, further comprising:
code responsive to the receipt of the solicitation, for presenting the alert on a multiplicity of user workstations; and
code responsive to the generation of the activation signal, to prevent another user from selecting the solicitation for dealing.

58. A computer-readable storage medium encoded with a program executable by a computer to conduct a financial transaction, the program comprising:
code configured to receive, via a data communications channel, a solicitation for the financial transaction;
code configured to present, on a user workstation,
an alert indicating that the solicitation has arrived, and
a user-activatible control configured to generate an activation signal, responsive to the input of a user, indicating that the user has selected the solicitation for dealing, and
code responsive to the generation of the activation signal,
to display the financial transaction to the user,
to receive a transaction term from the user for the financial transaction, and
to send the transaction term over the data communications channel.

59. The computer-readable storage medium of claim 58, wherein the program includes:
code for presenting the alert on a multiplicity of user workstations; and
code responsive to the generation of the activation signal, to prevent another user from selecting the solicitation for dealing.

60. A computer-implemented method for conducting a financial transaction, comprising:
receiving a solicitation for the financial transaction from a first user;
presenting the solicitation to a second user;
receiving from the second user a transaction term responsive to the solicitation;
transmitting the transaction term to the first user;
receiving from the first user an offer to deal responsive to the transaction term;
transmitting the offer to deal to the second user;
receiving from the second user a deal completion signal responsive to the offer to deal;
sending the deal completion signal to the first user;
executing the financial transaction; and
sending a confirmation.

61. The method of claim 60, further comprising creating or modifying a financial transaction database.

62. The method of claim 60, wherein the deal completion signal comprises an acceptance of the offer to deal.

63. The method of claim 60, wherein the deal completion signal comprises a rejection of the offer to deal.

64. The method of claim 60, wherein the deal completion signal comprises a command to withdraw the transaction term.

65. The method of claim 60, wherein the deal completion signal comprises a command to stop dealing on the financial transaction.

66. A programmed computer for conducting a financial transaction, comprising:
a processor configured to receive, via a data communications channel, a solicitation for the financial transaction, and for presenting an alert indicating that the solicitation has arrived; and
a memory having at least one region for storing computer-executable program code;
wherein the program code is configured to generate an activation signal in response to an input of a user, the input indicating that the user has selected the solicitation for dealing; and
the processor, responsive to the generation of the activation signal, is configured to display the financial transaction to the user,
to receive a transaction term from the user for the financial transaction, and
to send the transaction term over the data communications channel.

67. The programmed computer of claim 66, wherein the transaction term comprises a price quote.

68. The programmed computer of claim 66, wherein the alert comprises a visual signal.

70. The programmed computer of claim 68, wherein the visual signal comprises a summary of the solicitation.

71. The programmed computer of claim 68, wherein the visual signal comprises a flashing icon.

72. The programmed computer of claim 66, wherein the activation signal is generated by selecting a summary of the financial transaction with a pointing device coupled to the programmed computer.

73. The programmed computer of claim 66, wherein the activation signal is generated by typing a designated set of characters on the user workstation.

74. The programmed computer of claim 66, wherein the alert comprises an audible signal.

75. The programmed computer of claim 66, wherein the alert comprises a visual signal and an audible signal.

76. The programmed computer of claim 66, wherein the financial transaction comprises a currency exchange transaction.

77. The programmed computer of claim 66, wherein the financial transaction comprises a money market transaction.

78. The programmed computer of claim 66, wherein the processor is further configured, responsive to the input,. to send a notification over the data communications channel that the solicitation has been selected for dealing.

79. The programmed computer of claim 66, wherein the processor is further configured to receive an offer to deal responsive to the transaction term.
